(19) United States
(12) Patent Application Publication
(10) Pub. No.: US 2011/0282048 A1
(43) Pub. Date: Nov. 17, 2011

(54) Cross-Linking Involving a Polymeric Carbohydrate Material

(75) Inventors: Harry Brumer, Johanneshov (SE); Mark William Rutland, Sollentuna (SE); Michael L. Sinnott, Appley Bridge Wigan (GB); Tuula Telervo Teeri, Taby (SE); Qi Zhou, Taby (SE)

(73) Assignee: Swe Tree Technologies AB, Umea (SE)

(21) Appl. No.: 11/795,464

(22) PCT Filed: Jan. 25, 2006
(86) PCT No.: PCT/EP06/00630

§ 371 Date: May 15, 2008

Related U.S. Application Data
(60) Provisional application No. 60/646,488, filed on Jan. 25, 2005.

(51) Int. Cl. C08B 1/00; C08B 37/06; B01J 19/12; C08B 37/14; C08G 63/91; B01J 19/08; C08B 31/00; C08B 37/00

(52) U.S. Cl. 536/57; 536/56; 536/106; 536/123.1; 536/121; 525/54.23; 204/157.63; 204/157.68

(57) ABSTRACT

The present invention relates to a method of cross-linking a polymeric carbohydrate material with a second material by means of a soluble carbohydrate polymer and a crosslinking agent. The present invention furthermore relates to the resulting cross-linked material, to uses of the cross-linked material, as well as to a kit comprising the soluble carbohydrate polymer and the cross-linking agent.

### FIELD OF THE INVENTION

The present invention relates to a method of cross-linking a first polymeric carbohydrate material (PCM) to a second material using a soluble carbohydrate polymer (SCP), which will bind to the PCM, and a cross-linking agent (CLA) comprising at least a first activatable linking group (ALG) and typically also a second ALG. The second material may e.g. be a second PCM. Furthermore, the present invention relates to cross-linked materials obtainable by the method, kits comprising a SCP and a CLA, and various uses.

### BACKGROUND

Virtually all cellulose materials used in the paper, board and textile industries are chemically treated to alter the surface properties of these materials, either before (e.g. wood pulp, cotton thread, etc.) or after formation of the product in its final three-dimensional form (e.g. paper sheets, corrugated cardboard, woven fabrics, etc). Treatment of cellulose materials with chemical additives at various points in the manufacturing process leads to dramatic changes in fibre surface properties. For example, carboxymethylcellulose, an anionic cellulose derivative, is added to wood pulps to increase the retention of commonly used cationic fillers and sizing agents.

Despite advances in the development and application of various additives, a strong demand for compounds or materials remains which enhance fiber-fiber bonding leading to an observed increase in strength properties, for example in paper and board products. Particularly, there is much interest in additives which allow the reduction of fiber density while simultaneously maintaining various strength properties, e.g. tensile index, tear index, and burst strength. Furthermore, it is important for many applications to be able to control the dimensional stability of fibres and fibre products in varying degrees of humidity.

The currently available technology for cellulose fibre surface modification by chemical treatments lacks a high degree of control in the manner by which agents are introduced onto the fibre surface. A particularly serious shortcoming of direct chemical modification of cellulose is that most chemicals penetrate into the fibre structure and the chemical modifications occurring inside the fibres lead to loss of fibre structure and properties. In particular, reactions carried out on the hydroxyl groups of cellulose, whose inter- and intramolecular hydrogen bonds are responsible for the intrinsic material properties of cellulose, will disrupt the cellulose structure and negatively affect, for example, strength properties. Thus, there is a need to develop processes for the introduction of a wide range of chemical groups with different functionalities on polymer carbohydrate materials and in particular on cellulose fibres without compromising the intactness of the fibre structure. To overcome the aforementioned problems, methods which allow the deposition of surface chemistries onto cellulose via molecules or molecular fragments which exhibit a high affinity for crystalline or amorphous regions of cellulose fibrillar structures are particularly attractive.

WO 03/033 813 discloses a process for the chemical and enzymatic modification of carbohydrate polymers using e.g. xyloglucan as a carrier for the modification.

U.S. Pat. No. 6,844,081 discloses a wood product made from treating wood with two solutions, in series, including a penetrating solution and a topcoat composition. The penetrating solution may contain boric acid.

Christiernin et al. discloses a method where xyloglucan is adsorbed to and thereby cross-link cellulose fibers.

### SUMMARY OF THE INVENTION

An object of the present invention is to provide a fast method of cross-linking a polymeric carbohydrate material (PCM), preferably to a second material.

An object of the present invention is to provide an economical method of cross-linking a polymeric carbohydrate material (PCM).

Another object of the present invention is to provide a method of cross-linking which does not damage the PCM that are cross-linked.

Yet another object of the present invention is to provide methods of cross-linking a PCM, which results in a cross-linked PCM having an increased tensile strength.

Still another object of the present invention is to provide methods of cross-linking a PCM, which results in a cross-linked PCM having improved optical properties.

Other objects of the invention will become apparent when reading the description and the examples.

A broad aspect of the present invention relates to a method of cross-linking a first polymeric carbohydrate material (PCM) to a second material using a soluble carbohydrate polymer (SCP) and a cross-linking agent (CLA). In a preferred embodiment of the invention, the second material is a second PCM.

Thus an aspect of the invention relates to a method of cross-linking a first polymeric carbohydrate material (PCM) and a second material, the method comprising the steps:

a) providing a composition comprising said first PCM, said second material, a soluble carbohydrate polymer (SCP) and a cross-linking agent (CLA), said SCP being capable of binding to the first PCM, said CLA comprising a first activatable linking group (ALG) and a second ALG,
b) binding the SCP to the first PCM, and
c) cross-linking the first PCM and the second material via the SCP and the CLA and by activating the first ALG and/or the second ALG by at least one method of activation.

Another aspect of the present invention related to cross-linked materials obtainable by the method.

Yet another aspect of the invention relates to a cross-linked material comprising a first PCM cross-linked with a second material, wherein the cross-link comprises a SCP bound to the first PCM and a reacted CLA bound both to the SCP and the second material.

Still a further aspect of the invention relates to a kit comprising a SCP and a CLA.

Yet a further aspect of the invention relates to the use of the various materials in a wide range of applications.

### BRIEF DESCRIPTION OF THE FIGURES

In the following some embodiments of the present invention will be described with reference to the figures, wherein

FIG. 1 illustrates the method steps of a first exemplary embodiment of the invention,

FIG. 2 shows several types of CLAs,

FIG. 3 shows Mn and Mw/Mn of the free polymers and cleaved polymers as a function of monomer conversion,

FIG. 4 shows a plot of reflectance FTIR spectra of poly(MMA) grafted filter paper.

FIG. 5 shows a photo of the hydrophobic filter paper repelling a water droplet,

FIG. 6 shows bar graphs of tensile strength index of cross-linked paper compared to controls,

FIG. 7 illustrates the method steps of a second exemplary embodiment of the invention,

FIG. 8 illustrates the method steps of a third exemplary embodiment of the invention,

FIG. 9 illustrates a variant of the method steps illustrated in FIG. 8,

FIG. 10 illustrates the method steps of a fourth exemplary embodiment of the invention, and

FIG. 11 shows the plot for determining the maximum absorbable concentration of SCP.

### DETAILED DESCRIPTION OF THE INVENTION

A broad aspect of the present invention relates to a method of cross-linking a first polymeric carbohydrate material (PCM) to a second material using a soluble carbohydrate polymer (SCP) and a cross-linking agent (CLA). In a preferred embodiment of the invention, the second material is a second PCM.

Thus an aspect of the invention relates to a method of cross-linking a first polymeric carbohydrate material (PCM) and a second material, the method comprising the steps:

a) providing a composition comprising said first PCM, said second material, a soluble carbohydrate polymer (SCP) and a cross-linking agent (CLA), said SCP being capable of binding to the first PCM, said CLA comprising a first activatable linking group (ALG) and a second ALG,
b) binding the SCP to the first PCM, and
c) cross-linking the first PCM and the second material via the SCP and the CLA and by activating the first ALG and/or the second ALG by at least one method of activation.

The term “and/or” used in the context “X and/or Y” should be interpreted as “X”, or “Y”, or “X and Y”.

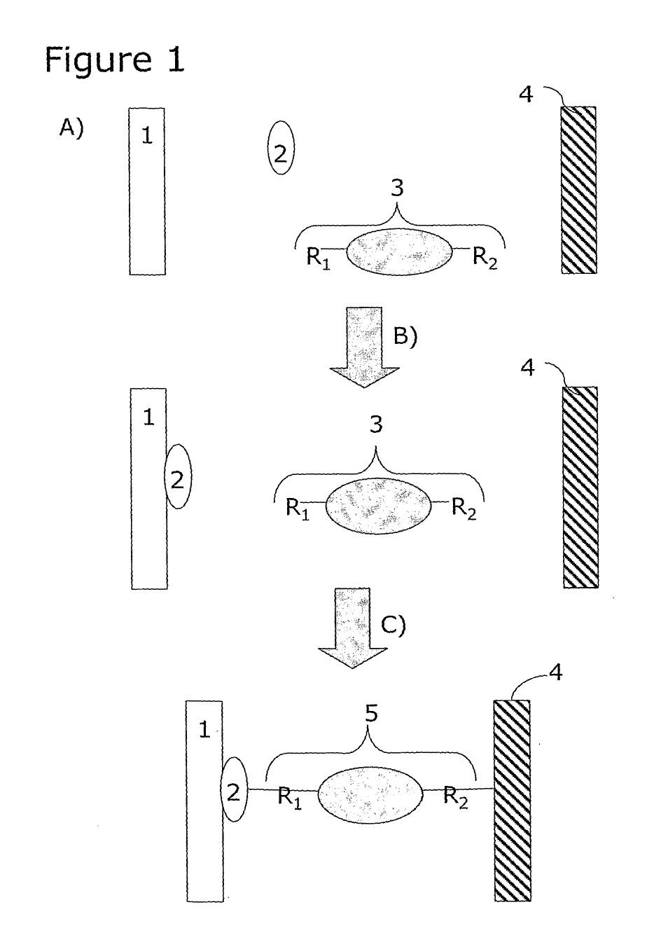

An exemplary embodiment of the method is schematically depicted in FIG. 1, showing in step a) a composition comprising the first PCM (1), the SCP (2), the CLA (3) comprising the first ALG (R₁) and the second ALG (R₂), and the second material (4). In step b) the SCP is being bound to the first PCM, thus a complex between the first PCM and the SCP is formed. In step c) both the first ALG and the second ALG are activated by a method of activation and consequently bonds are formed between the first PCM-bound SCP and the CLA and between the CLA and the second material.

Typically, an ALG can form at least one bond to another molecule upon activation by at least one method of activation.

In an alternative embodiment of the invention, the SCP may already be bound to the first PCM when provided and thus relates to a method of cross-linking a first polymeric carbohydrate material (PCM) and a second material, the method comprising the steps:

a) providing a composition comprising said first PCM, said second material, a soluble carbohydrate polymer (SCP) bound to the first PCM, and a cross-linking agent (CLA), said CLA comprising a first activatable linking group and optionally also a second activatable linking group, and
c) cross-linking the first PCM and the second material via the SCP and the CLA by activating the first activatable linking group and/or the second activatable linking group by at least one method of activation.

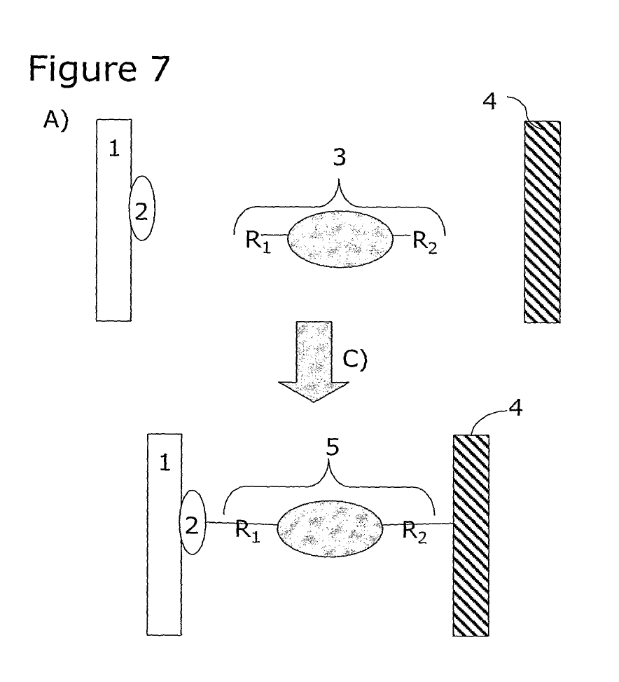

An exemplary embodiment of this method is schematically depicted in FIG. 7, showing in step a) a composition comprising the first PCM (1) bound to the SCP (2), the CLA (3) comprising the first ALG (R₁) and the second ALG (R₂), and the second material (4). In step c) both the first ALG and the second ALG are activated by a method of activation and consequently bonds are formed between the first PCM-bound SCP and the CLA and between the CLA and the second material.

The SCP bound to the first PCM may e.g. be prepared by means of a coating process or a coating like process. A concentrated solution of the SCP may e.g. be sprayed, layered, spun, spotted or otherwise added to the surface of the PCM by a mechanical process. The concentrated solution of SCP may e.g. be a gel. The concentrated solution of SCP typically comprises water and optionally also other co-solvents. Water and any co-solvents are normally removed from the composition by a drying step.

Preferred embodiments of the invention relate to a method of cross-linking a first polymeric carbohydrate material (PCM) and a second PCM, the method comprising the steps:

a) providing a composition comprising said first PCM, said second PCM, a soluble carbohydrate polymer (SCP) and a cross-linking agent (CLA), said SCP being capable of binding to the first PCM, said CLA comprising a first activatable linking group (ALG) and a second ALG,
b) binding the SCP to the first PCM, and
c) cross-linking the first PCM and the second PCM via the SCP and the CIA by activating the first ALG and/or the second ALG by at least one method of activation.

In an alternative embodiment of the invention, the SCP may already be bound to the first PCM when provided and thus relates to a method of cross-linking a first polymeric carbohydrate material (PCM) and a second PCM, the method comprising the steps:

a) providing a composition comprising said first PCM, said second PCM, a soluble carbohydrate polymer (SCP) bound to the first PCM, and a cross-linking agent (CLA), said CLA comprising a first activatable linking group and a second activatable linking group, and c) cross-linking the first PCM and the second PCM via the SCP and the CLA by activating the first activatable linking group and/or the second activatable linking group by at least one method of activation.

Typically a CLA comprises a first activatable linking group (ALG) and a second ALG. Normally, an ALG can form at least one bond to another molecule upon activation by at least one method of activation.

The CLA may furthermore comprise a spacer group to which the ALGs, e.g. the first and second activatable linking group, are bound.

The spacer group may e.g. comprise a component selected from the group consisting of an atom, a small organic molecule, a polypeptide, a protein, a carbohydrate, a nano particle, an ordered or disordered cluster of atoms.

An ordered or disordered cluster of atoms may for example comprise metals, inorganic substances, or organic materials such as polymers

The spacer group may e.g. comprise a component selected from the group consisting of an electrical conductor, a thermal conductor, a semi conductor; a thermal insulator, and an electrical insulator.

It is also envisioned that the spacer group may be an aggregate of the above-mentioned components. For example, the spacer group may be an aggregate of cross-linked proteins or carbohydrates, such as an aggregate of cross-linked SCPs.

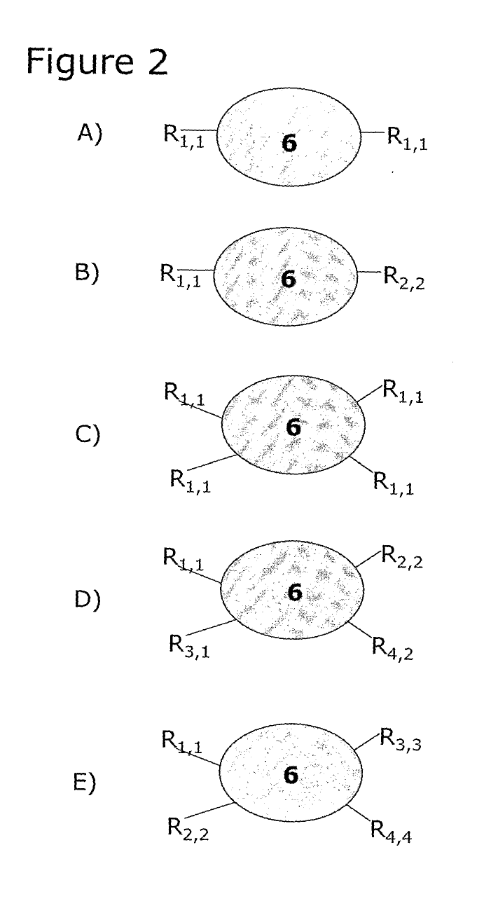

A range of different CLA structures is envisioned and five important embodiments of the CLA are schematically depicted in FIG. 2. The CLAs of FIG. 2 all comprise a spacer group (6) and furthermore comprise a first ALG and a second ALG bound to the spacer group. In FIG. 2, the syntax R_{i,j} denotes the ith ALG which is activatable by the jth method of activation, thus R_{1,1} is a first ALG which is activatable by the first method of activation, and R_{4,2} is the fourth ALG which is activatable by the second method of activation.

The CLA of FIG. 2.A could for example be a dialdehyde, where the two aldehyde groups are the first and the second ALG and the carbon-chain are the spacer-group. The CLA of FIG. 2.B could for example be one of the photo-activatable linkers used in the examples. The CLA of FIG. 2.C could for example be a borate ion, B(OH)₄⁻, where the hydroxy groups are the four ALGs and the boron atom is the spacer group.

The CLA of FIGS. 2.D and E are typical for CLAs with larger spacer groups to which a range of different ALGs may be bound.

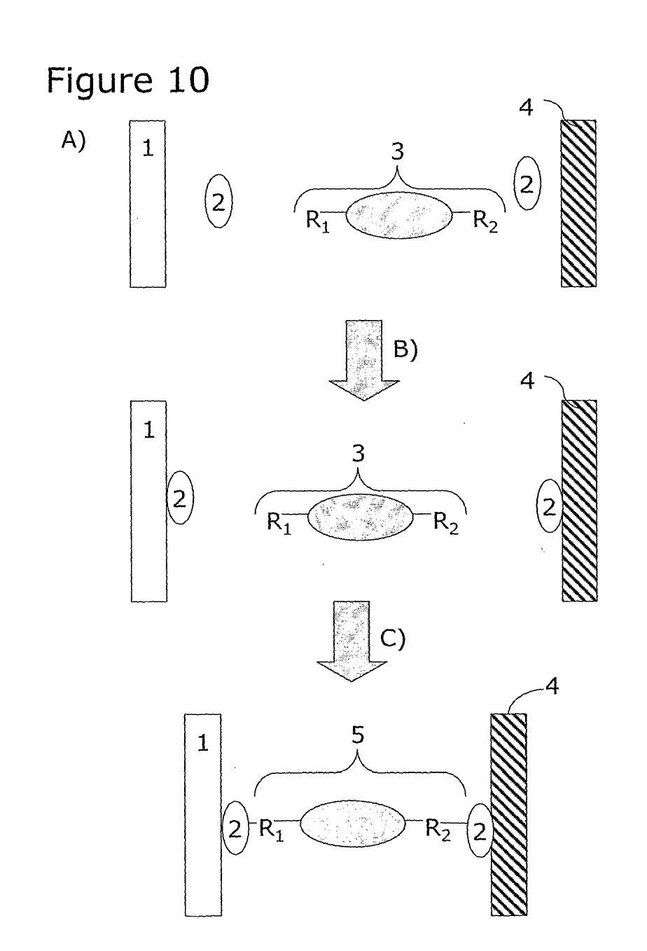

An exemplary embodiment of the method of the invention, which is useful when the second material is a second PCM and in particular when the CLA is a boron compound, is schematically depicted in FIG. 10. Step a) provides a composition comprising the first PCM (1), two SCPs (2), the CLA (3) comprising the first ALG (R₁) and the second ALG (R₂), and the second PCM (4). In step b) SCP is both bound to the first PCM and the second PCM. In step c) both the first ALG and the second ALG are activated by a method of activation and consequently bonds are formed between the first PCM-bound SCP and the CLA and between the CLA and the second PCM.

As mentioned, the CLA may furthermore comprise additional ALGs, such as a third ALG, a fourth ALG. For example, the CLA may comprise an average number of ALGs in the range of 2-100000, such as 2-5, 5-10, 10-20, 20-50, 50-100, 100-200, 200-500, 500-1000, or 1000-10000, such as 10000-100000.

In an embodiment of the invention, the first and second ALG can be activated via the same method of activation. In this case the first and second ALG may e.g. be of the same type. In another embodiment of the invention, the first ALG cannot be activated by a method of activation of which the second ALG can be activated. Typically cross-linking is performed by first using the method of activation that exclusively actives the first or the second ALG and subsequently using the method of activation that activates both ALG's.

In yet another embodiment of the invention, the second ALG cannot be activated by a method of activation of which the first ALG can be activated. In a preferred embodiment, there exists a first method of activation of which the first ALG can be activated, but of which the second ALG cannot be activated, and a second method of activation of which the second ALG can be activated, but of which the first ALG cannot be activated.

In a special embodiment, the CLA comprises a functional component. The functional component may e.g. modify a property of the first PCM and/or the second material such as modifying the strength, modifying the colour, modifying the roughness, modifying optical properties, modifying the wettability, modifying the thermal conductivity, modifying the electric conductivity, modifying the magnetic properties, modifying the growth conditions of micro-organisms e.g. by inclusion of biocides, modifying the smell, or combinations thereof.

Also the functional component may e.g. modify a property of the first PCM and/or the second material such as modifying the transparency, modifying the reflectivity, rendering it more hydrophilic or more hydrophobic, making it gas impermeable or making it semi gas-permeable.

The functional component may also give the first PCM and/or the second material a molecular sieve functionality, allow to act as a molecular sensor, or act as reinforcement or armouring of the first PCM and/or the second material.

Modifying optical properties via the functional component may e.g. be relevant for making video screens on paper.

Thus, the functional component may e.g. comprise a component selected from the group consisting of an electrical conductor, a thermal conductor, a semi conductor; a thermal insulator, an electrical insulator, a paramagnetic material, and a super paramagnetic material.

The spacer group may comprise the functional component.

The spacer group may comprise at most 99.5% xyloglucan, such as at most 99%, 95%, 90%, 80%, 70%, 60%, 50%, 40%, 30%, 20%, 10%, or 5%, such as at most 1% xyloglucan.

In an embodiment of the invention, the spacer group does not comprise xyloglucan. In another embodiment the spacer group is not a SCP.

The spacer group may comprise at most 100%, 99.5% cellulose, such as at most 99%, 95%, 90%, 80%, 70%, 60%, 50%, 40%, 30%, 20%, 10%, or 5%, such as at most 1% cellulose.

In an embodiment of the invention, the spacer group does not comprise cellulose and in a further embodiment the spacer group is not a PCM.

It is envisioned that the CLA may have large variety of sizes and shapes. However, normally the longest dimension of the CLA are at most 100 μm, such as at most 50 μm, 25 μm, 10 μm, 5 μm, or at most 1 μm, such as e.g. at most 500 nm, 250 nm, 125 nm, 100 nm, 75 nm, 50 nm, 25 nm, 12.5 nm, 10 nm, 5 nm, 2.5 nm, 1.25 nm, 1.0 nm, 0.5, or at most 0.1 nm.

For some embodiments it is preferred to have a CLA having a longest dimension of at least 1 nm such as at least 10 nm, preferably of at least 1 μm such as at least 5 μm, and even more preferably of at least 10 μm, such as at least 25 μm.

Typically, the longest dimension of the CLA is in the range 0.1 nm-100 μm. The longest dimension of the CLA may e.g. be in the range 0.1 nm-1 nm, in the range 1 nm-1 μm, or in the range 1-100 μm.

For some applications, it is important to use CLA's of or exceeding a certain length to obtain a sufficient strength of the cross-linking between the first PCM and the second material.

ALGs may include any of a wide range of groups which can participate in cross-linking reactions including, but not limited to, those containing or capable of generating: carbocations, metal cations, alcoxides, thiolates, phosphonates, carbanions, carboxylates, boronates, sulfonates, amino acids, ylides (or the unionised conjugate acids or bases of these groups, as appropriate), nitrenes, carbenes, or other electron-rich or electron-deficient species; unsaturated alkyl (e.g, fatty acyl or alkyl groups) or aryl hydrocarbons (e.g, aromatic or polycyclic aromatic hydrocarbons or heterocycles); carbohydrates; or polypeptides and proteins.

Thus, examples of ALGs suitable for cross-linking include ionic groups, hydrocarbons, electrophilic groups, nucleophilic groups, reagents for polymerisation reactions, radioactive isotopes, free-radical precursors, carbene precursors, nitrene precursors, oxene precursors, nucleic acid sequences, amino acid sequences, polypeptides, proteins, carbohydrates, vitamins and drugs.

In an embodiment of the invention at least one of the ALGs is not a hydroxy group.

In an embodiment of the invention, at least one of the ALGs is an ionic group (cationic, e.g. quaternary amino groups, ammonium groups, carbocations, sulfonium groups, or metal cations, etc.; anionic, e.g., alcoxides, thiolates, phosphonates, carbanions, carboxylates, boronates, sulfonates, Bunte salts, etc.; or zwitterionic, e.g., amino acids, ylides, or other combinations of anionic and cationic groups on the same molecule) or their unionised conjugate acids or bases.

In an embodiment of the invention, at least one of the ALGs is a hydrocarbon group, e.g. selected from the group consisting of an alkane, an alkene, an alkyne, an aromatic or polycyclic aromatic hardcarbon and heterocycles uncharged hydrophilic group (e.g. polyethers, such as polyethylene glycol), and combinations thereof.

In an embodiment of the invention, at least one of the ALGs is an electrophilic group, e.g. selected from the group consisting of an alkyl halide, an acetal, a carbonyl group, an alkene, an alkyne, an allene, an aromatic hydrocarbon, an aromatic heterocycle, a boron compound, a carbocation, a metal cation, a xenon atom or compound based on xenon, and derivatives thereof.

In an embodiment of the invention, at least one of the ALGs is a nucleophilic group, e.g. selected from the group consisting of amines, thiols, hydroxyls, carbanions, enolates, alkenes, alkynes, allenes, aromatic hydrocarbons, aromatic heterocycles, metals, and derivatives thereof.

In an embodiment of the invention, at least one of the ALGs is a reagent for a polymerisation reaction, e.g. selected from the group consisting of acrylamide, bromobutyrate, vinyl, styrene, methylmethacrylate and derivatives thereof.

In a preferred embodiment of the present invention, the chemical group may be selected among polymerisation initiators or it may be selected among monomers for polymerisation reactions.

An ALG may be a photo-activatable group. For example, a CLA comprising an activatable linking group, which is a photo-activatable group, may be a CLA selected from an aryl azide, a cinnamic acid and derivatives thereof.

Useful derivatives of cinnamic acid are e.g. coumaric acid (4-hydroxy cinnamic acid), coniferic acid (3-methoxy-4-hydroxy cinnamic acid), and sinapic acid (3,5-dimethoxy-4-hydroxy cinnamic acid).

The photo-activatable group may e.g. be a 4-azidobenzoyl group.

Other useful photo-activatable groups may e.g. be found in Oldring et al. 1 and in Oldring et al. 2; the contents of both are incorporated herein by reference for all uses.

The CLAs are readily prepared using e.g. standard organic synthesis and/or conventional conjugation techniques. These techniques for preparing the CLA via standard organic synthesis or conventional conjugation are described in a number of handbooks such as March, Smith et al., and Collins et al., and are thus readily available for the person skilled in the art.

In an important embodiment of the present invention, the SCP of step a) comprises the CLA, that is, the SCP is bound to the CLA when provided. In this embodiment the first or second ALG of the CLA has already been activated, thus forming the bond between the SCP and the CLA.

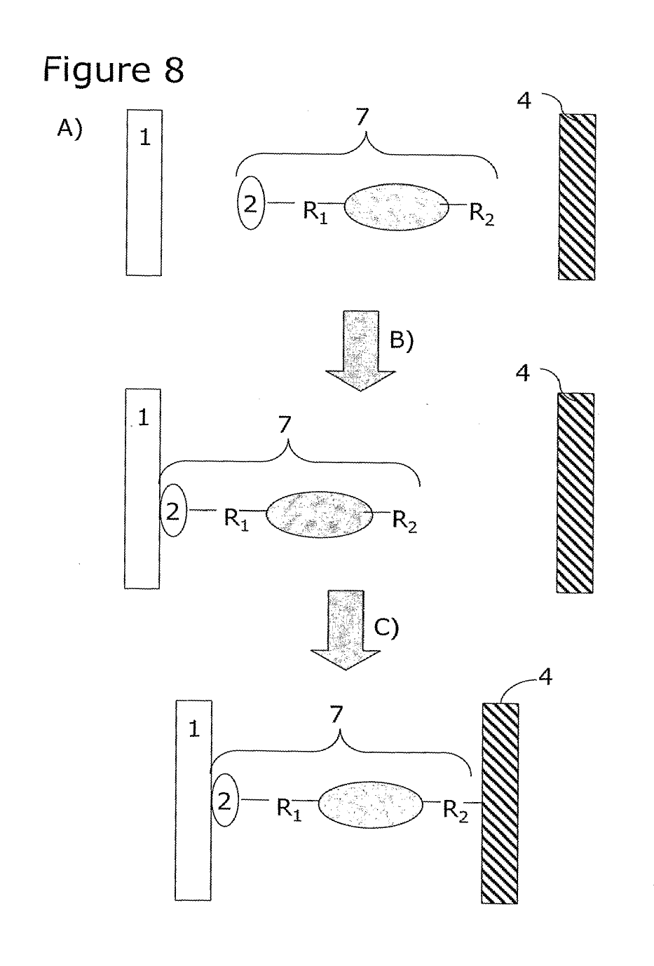

An exemplary embodiment of this method is schematically depicted in FIG. 8, showing in step a) a composition comprising the first PCM (1), the SCP (2), the CLA (3) comprising the first ALG (R₁) and the second ALG (R₂), and the second material (4). SCP has already been bound to the CLA via the first ALG prior to step a) to form a SCP-CLA molecule (7). In step b) the SCP is being bound to the first PCM, thus a complex between the first PCM and the SCP-CLA is formed. In step c) the second ALG are activated by a method of activation and consequently bonds are formed between the CLA and the second material.

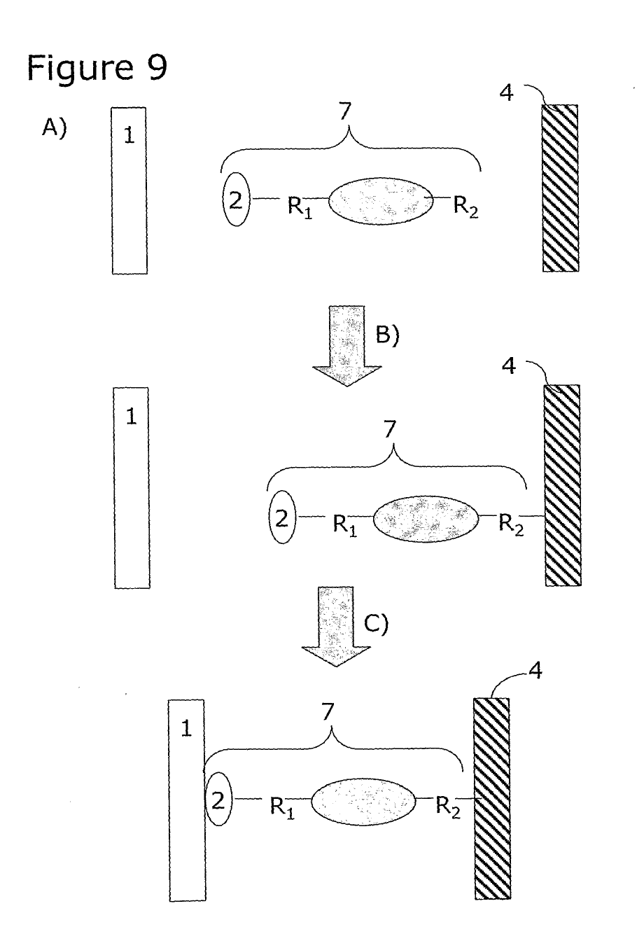

As shown in FIG. 9, the method illustrated in FIG. 8 may be modified by binding the SCP-CLA molecule to the second material in step b) and forming the bond to the first PCM via the SCP in step c).

In another important embodiment, the SCP of step a) does not comprise the CLA, that is, the SCP is not bound to the CLA when provided.

It is also envisioned that the composition of step a) both comprises the SCP bound to the CLA, SCP is not bound to the CLA, and CLA is not bound to the SCP.

In a preferred embodiment of the present invention, the composition comprises reacted CLA comprising elemental boron, such as a boron ester or derivatives thereof.

For example, 0.000000001%-50% of the weight of the composition is comprised by elemental boron, such as 0.000000001%-0.0000001%, 0.0000001%-0.00001%, 0.00001%-0.001%, 0.001%-0.01%, 0.01%-0.1%, 0.1%-1%, 1%-5%, 5%-10%, such as 10%-50% elemental boron.

The composition may furthermore comprise a divalent metal cation. The divalent metal cation may e.g. be selected from the group consisting of Mg²⁺, Ni²⁺, Cu²⁺, Zn²⁺, Cd²⁺+, Ca²⁺, Sr²⁺, Pb²⁺, and Ba²⁺.

In a preferred embodiment of the present invention, the divalent metal cation is Ca²⁺.

The CLA may comprise a reacted dialdehyde, such as a C2-C8 dialdehyde. For example, the dialdehyde may be glutardealdehyde.

In the present context, the phrase a “method of activation” relates to a process and/or one or more sets of conditions to which the composition should be exposed in order to activate an ALG and thus forming a bond of a cross-link.

The method of activation may e.g. be selected from the group consisting of
exposing the composition to ionizing radiation,
exposing the composition to electromagnetic radiation,
creating an acidic pH in the composition,
creating a basic pH in the composition,
providing a suitable solvent,
creating a certain temperature in composition,
adding a catalyst/chemical activator, and
combinations thereof.

In a preferred embodiment, the method of activation is exposing the composition to electromagnetic radiation, e.g. as described in Examples II and III.

The time and intensity of the exposure varies from application to application and readily determined by a person skilled in the art. Typically, the composition is exposed to the electromagnetic radiation for a duration in the range of 0.001 second-20 hours, such as e.g. 0.001-1 second, 1-10 seconds, 10-30 seconds, 30-60 seconds, 1-10 minutes, 10-30 minutes, 30-60 minutes 1-5 hours, 5-10 hours, or 10-20 hours.

For some applications, it will be useful to employ a relatively short time of exposure such as in the range of 0.001-60 second. For other applications a somewhat longer time of exposure will be beneficial such as e.g. 60 seconds-1 hour.

The term “electromagnetic radiation” is to be broadly interpreted and encompasses e.g. gamma rays, X-rays, ultraviolet radiation, radiation within the visible spectrum, infrared radiation, and even higher wavelength radiation such as e.g. microwave radiation and radio frequency radiation.

In an embodiment of the invention, the electromagnetic radiation comprises a wavelength within the wavelength range 150 nm-1500 nm, such as within 150 nm-400 nm, 400 nm-700 nm, or 700 nm-1500 nm.

Normally, at least 10% of the energy of the electromagnetic radiation, to which the composition is exposed, consists of wavelengths within the wavelength range 150 nm-1500 nm, such as within 150 nm-400 nm, 400 nm-700 nm, or 700 nm-1500 nm.

For example, at least 50%, 60%, 70%, 80%, 90%, 95%, or at least 99% of the energy of the electromagnetic radiation, to which the composition is exposed, consists of wavelengths within the wavelength range 150 nm-1500 nm, such as within 150 nm-400 nm, 400 nm-700 nm, or 700 nm-1500 nm.

Ionizing radiation e.g. comprises radiation by means of a particle beam such as a neutron beam, an electron beam, or a ion beam. The above-mentioned exposure times applies to ionizing radiation as well.

It is furthermore envisioned that the method of activation may be exposing the composition to a combination of electromagnetic radiation and ionizing radiation.

The composition may comprise photo-initiators when exposed to electromagnetic radiation and/or ionizing radiation. Suitable photo-initiators are found in Oldring et al. 1 and in Oldring et al. 2 and the contents of both publications are incorporated herein by reference for all uses.

Creation of an acidic pH in the composition is typically performed by addition of organic or inorganic acids (proton donors, i.e Brønsted acids), or via reactions (such as redox reactions or enzyme catalyzed reactions) which generate protons (hydronium ions).

Creation of a basic pH in the composition it normally performed by addition of organic or inorganic bases (proton acceptors, i.e Brønsted bases), or via reactions (such as redox reactions or enzyme catalyzed reactions) which consume protons (hydronium ions).

Providing a suitable solvent may e.g. be relevant for ALGs that will only react in an aqueous solvent or in an organic solvent. The effect of solvent on reaction rates is well known and is e.g. described in March. In particular, reactions involving ionic intermediates are generally more rapid in polar solvents. Where the solvent is itself a reactant (e.g. in hydrolysis reactions, solvolosis reactions, and transesterifications, among others), the choice of solvent is especially important.

Creation of certain temperature in composition is readily performed using any source of energy, such as electrical or optical. Heating the reaction to cause thermal decomposition or thermal activation of a chemical group. The rate of most every reaction is increased with increasing temperature.

Many reactions can be affected by the addition of a catalyst or a chemical activator. Transition metal catalysts are common, as are enzymes. Also, acid and base catalysis is well known in many systems. There are many strategies for the removal of protecting groups which e.g. may be found in Kocienski; Kolb et al. and in Greene & Wuts. The contents of these three publications are incorporated herein by reference for all uses.

Typical methods of activiation are e.g.:

i) Aqueous solvent; temp: 25° C.; around pH 7,
ii) Aqueous solvent; temp: 25° C.; around pH 7, exposure to electromagnetic radiation in the UV range,
iii) Aqueous solvent; temp: 25° C.; around pH 7, exposure to electromagnetic radiation in the visible range
iv) Aqueous solvent; temp: 25° C.; around pH 2-4, and optionally presence of a divalent metal cation (relevant for the boron compounds), or
v) Evaporating solvent; temp: 25-50° C.; around pH 2-4; and optionally presence of a divalent metal cation.

The methods of activation ii) and iii) are typical for the cross-linking aspect using photo-linkers.

The methods of activation iv) and v) are especially useful for cross-linking using boric acid as a CLA, e.g. in paper. Here the most significant cross-linking may occur when the sheet is heated during drying. Without being bound by theory, it is believed that water is driven off, so the reaction B(OH)3+sugar-OH−>sugar-O—B(OH)2+H2O is favoured, rather than the reverse reaction, which is hydrolysis of the sugar-boron bond.

The duration of the cross-linking reaction varies from application to application and is readily determined by a person skilled in the art. Typically, the duration of the cross-linking reaction is in the range of 0.001 second-20 hours, such as e.g. 0.001-1 second, 1-10 seconds, 10-30 seconds, 30-60 seconds, 1-10 minutes, 10-30 minutes, 30-60 minutes 1-5 hours, 5-10 hours, or 10-20 hours.

For some applications, it will be useful to employ a relatively short duration of the cross-linking reaction such as in the range of 0.001-60 seconds. For other applications a somewhat longer duration of the cross-linking reaction will be beneficial such as e.g. 60 seconds-1 hour.

In a preferred embodiment of the invention, the duration of the cross-linking reaction is at most 5 days, such as at most 2 days, 36 hours, 24 hours, 20 hours, 15 hours, 10 hours, 9 hours, 8 hours, 7 hours, 6 hours, 5 hours, 4 hours, 3 hours, 2 hours, such as at most 1 hour. In an especially preferred embodiment the duration of the cross-linking reaction is at most 60 minutes such as at most 50 minutes, 40 minutes, 30 minutes, 20 minutes, 15 minutes, 10 minutes, 5 minutes, 4 minutes, 3 minutes, or 2 minutes, such as at most 1 minute. For examples the duration of the cross-linking reaction may e.g. be at most 60 seconds, such as 50 seconds, 40 seconds, 30 seconds, 20 seconds, 15 seconds, 10 seconds, 5 seconds, 4 seconds, 3 seconds, or 2 seconds, such as at most 1 second. It is also envisioned the duration of the cross-linking reaction may be even shorter such as at most 100 milisecond, 10 milisecond, or at most 1 milisecond, such as at most 0.1 milisecond.

The term “duration of the cross-linking reaction” relates to the time in which a method of activation is performed. When several different methods of activation are used in sequence, the duration of the cross-linking reaction relates to accumulated time in which any method of activation is performed.

An advantage of the present invention is that it allows for fast cross-linking processes.

The term “polymeric carbohydrate material”, which is abbreviated “PCM”, relates to a material that comprises a water-insoluble polymeric carbohydrate material and/or a water-soluble polymeric carbohydrate material. The PCM may be any material, which wholly or partly is made up of repeating units of one or more monosaccharides. Such PCMs are often composites with two or more different types of polymeric carbohydrates or a carbohydrate polymer and another polymers such as protein. The PCM may comprise a chitin (poly(N-acetylglucosamine)) or chitosan (poly(glucosamine)), which often forms complexes with proteins or other polysaccharides such as mannan.

The PCM may comprise cellulose, which is a homopolymer of β-1,4-linked glucose units. The long homopolymers of glucose (e.g. 8-15000 glucose units) stack onto one another by hydrogen bonds, thus forming an insoluble material. Such cellulose materials may be completely crystalline, or they may occur in disordered, amorphous form or they may be a mixture of the two. They may also be produced by first solubilizing the insoluble cellulose material and then regenerating it to form insoluble cellulose material of the same or different chain organization (cellulose II).

The first and/or the second PCM may be derived from a source selected from the group consisting of a plant, a bacterium, an algea and an animal.

The plant may comprise a gymnosperm (non-flowering plant) or an angiosperm (flowering plant). Also, the angiosperm plant may be monocotyledonous or dicotyledonous. The plant may be perennial, bi-annual or annual.

In preferred embodiments, a perennial plant is a woody plant which has hard lignified tissues and forms a bush or tree. Preferred perennial plants are woody perennial plants such as trees, i.e. plants of tree forming species.

Examples of woody perennial plants include conifers such as cypress, fir, sequoia, hemlock, cedar, juniper, larch, pine, redwood, spruce and yew; hardwoods such as acacia, eucalyptus, hornbeam, beech, mahogany, walnut, oak, ash, willow, hickory, birch, chestnut, poplar, alder, maple and sycamore, and other commercially significant plants, such as cotton, bamboo and rubber.

In another preferred embodiment, the plant may be a moncotyledonous grass.

Other examples of plants are barley, hemp, flax, wheat, maize or palms.

Thus, in an embodiment of the invention, the first and/or the second PCM comprises a water-insoluble polysaccharide.

The first and/or the second PCM may comprise at least 5% cellulose, such as at least 10%, 20%, 30, 40%, 50%, 60%, 70%, 80%, 95%, or 99%, such as at least 99.9% cellulose, such as e.g. 100% cellulose.

The method of the present invention may both be applied to pre-fabricated PCM-containing products and to simpler embodiments of PCM such as e.g. complex composite material to a single cellulose microcrystal.

Thus, the first and/or the second PCM of step a) of claim 1 may also form part of a structure selected from the group consisting of

i) microcrystalline cellulose, e.g. wherein the microcrystals have been prepared by chemical or enzymatic hydrolysis of cellulose,
ii) cellulose microfibrils, for example prepared from plant fibres, animal sources or produced by cultivation of cellulose producing bacteria such as for example Acetobacter spp.,
iii) regenerated cellulose, e.g. prepared by regeneration of solvent solubilized cellulose by removal of the solvent,
iv) plant fibers such as fibers extracted from plants,
v) partially defibrillated wood,
vi) wood,
vii) a fibre network, and
viii) composite materials comprising any combination of i)-vii).

The term “cellulose microfibrils” relates to the elementary units of cellulose crystals produced by plants or other organisms. Cellulose microfibrils can be prepared from cellulosic plant fibres, or more easily from cultures of cellulose synthesizing bacteria such as Acetobacter spp.

The plant fibre may for example be a wood fibre or a pulp fibre and may form part of a bleached or nonbleached chemical pulp, mechanical pulp, thermomechanical pulp, chemomechanical pulp, fluff pulp, or a paper pulp. The plant fibre may be prepared from any of the plants e.g. the plant mentioned herein

The fibre network may e.g. comprise paper or paperboards, cardboards, a thread such as a cotton thread, woven or non-woven fabric, filter papers, fine papers, newsprint, liner boards, tissue and other hygiene products, sack and Kraft papers.

The woven or non-woven fabric, may e.g. be any cellulose-containing fabric known in the art, such as cotton, viscose, cupro, acetate and triacetate fibres, modal, rayon, ramie, linen, Tencel® etc., or mixtures thereof, or mixtures of any of these fibres, or mixtures of any of these fibres together with synthetic fibres or wool such as mixtures of cotton and spandex (stretch-denim), Tencel® and wool, viscose and polyester, cotton and polyester, and cotton and wool.

The composite material may for example be packaging materials, e.g. for liquids and foodstuff; particle boards and fibre boards, fibre composites comprising other natural or synthetic polymers or materials as well as those which may be considered electrical conductors, semi-conductors, or insulators.

Corners and folds of shaped materials comprising PCMs are typically weak and would benefit from cross-linking according to the present method. The present method of cross-linking may for example be used for reinforcing corners and folds of shaped packaging materials.

Further examples of composite materials are e.g. a paper and cardboards, which are often laminated with a thermoplastic, such as polyethylene to provide an impermeable barrier to aqueous solutions, security papers, bank notes, a wood-polymer composite.

As will be apparent from the description and the examples, the structure of which the first PCM and/or the second PCM forms part, relates to any structures in small polymers (e.g. dimensions less than one nm), large polymers (e.g. dimensions of 0.1-1000 nm), aggregates of polymers (e.g. dimensions of 1-10.000 nm), fibres (e.g. dimensions of 0.1-100.000 μm), aggregates of fibres and composites (e.g. dimensions of 0.00001-1000 m).

The second material to which the first PCM is cross-linking may be selected from a wide array of materials such as e.g. plastics, metals, metal oxides, composite materials, biological materials such as tissue, cells, proteins and so forth.

In an embodiment of the invention, the second material comprises a plastic. For example, the cross-linking may result in the CLA being bound to the plastic of the second material.

In an embodiment of the invention, the second material comprises a metal. For example, the cross-linking may result in the CIA being bound to the metal of the second material.

In an embodiment of the invention, the second material comprises a metal oxide. For example, the cross-linking may result in the CIA being bound to the metal oxide of the second material.

In an embodiment of the invention, the second material comprises a semiconductor oxide. For example, the cross-linking may result in the CLA being bound to the semiconductor oxide of the second material.

In a preferred embodiment of the invention, the second material is a second PCM.

In another preferred embodiment of the invention, the second material is not a PCM, or the second material comprises less than 1% PCM by weight.

The term “soluble carbohydrate polymer” which is abbreviated (SCP), relates to a polymer, or an aggregate of polymers, comprising one or more different monosaccharides or their derivatives, which can be dissolved in aqueous or organic solvents. Examples include polysaccharides classified as hemicelluloses (those carbohydrate polymers which are not composed only of β(1-4)-linked glucose units, i.e., cellulose), pectins (polyuronic acids and esters), and starches (α(1-4)-linked polyglucose with or without a (1-6) sidechain branching). Xyloglucan, which is a polysaccharide composed of a (β(1-4)-linked polyglucose backbone decorated with α(1-6) xylose residues, which themselves can be further substituted with other saccharides such as fucose and arabinose, is an example of such a SCP, specifically a hemicellulose.

In a preferred embodiment the SCP is capable of binding to the PCM, e.g. via one or more hydrogen bonds, ionic interaction, one or more covalent bonds, van der Waals forces or any combination of these.

Thus, the SCP will typically comprise a component selected from the group consisting of a hemicellulose, a pectin and a starch.

In a preferred embodiment of the invention, the SCP comprises a hemicellulose, e.g. at least 1% hemicellulose, such as at least 2%, 5%, 10%, 20%, 30, 40%, 50%, 60%, 70%, 80%, 95%, or 99%, such as at least 99.9% hemicellulose, such as e.g. 100% hemicellulose.

It should be noted that normally the SCP comes from another source, i.e. another organism, than does the first PCM.

In a preferred embodiment of the invention, the SCP comprises the hemicellulose xyloglucan. The SCP may essentially consist of xyloglucan.

The SCP may comprise at least 1% xyloglucan, such as at least 2%, 5%, 10%, 20%, 30, 40%, 50%, 60%, 70%, 80%, 95%, or 99%, such as at least 99.9% xyloglucan, such as e.g. 100% xyloglucan.

In an embodiment of the present invention, the SCP comprises at most 100% xyloglucan, such as at most 99.9%, 99.5%, 99%, 95%, 90%, 80%, 70%, 60%, 50%, 40%, 30%, 20%, 10%, or 5%, such as at most 1% xyloglucan.

Xyloglucan from many different sources may be used. For example, the source of xyloglucan may be cell walls of various plants, such as e.g. pea or nasturtium, or it may be seeds of various plants, such as e.g., Tamarindus sp. or Brassica sp. Xyloglucan from tamarind seeds is presently preferred.

The SCP may comprise components selected from the group consisting of hemicelluloses and pectins, e.g., glucuronoxylans, xylans, mannans, glucomannans, galactoglucomannans, arabinoxylans, galacturonans, rhamnogalacturonan, especially rhamnogalacturonan II and xyloglucan.

Typically, the SCP comprises a reducing end, that is, an aldehyde group, at one of the ends of its carbohydrate backbone. More aldehyde groups may be formed by reacting the SCP with the enzyme galactose oxidase, which results in the formation aldehyde groups in the galactose-containing side chain of the SCP. Generally, the aldehyde groups are useful for attaching chemical groups or ALGs to the SCP. In a preferred embodiment of the invention, the SCP, preferably comprising xyloglucan, comprises it natural reducing end in the carbohydrate backbone, as well as one or more aldehyde groups in the side chain(s).

In an embodiment of the invention, at least one SCP is single molecule. In an embodiment of the invention, at least one SCP is an aggregate of molecules. In yet an embodiment, at least one SCP is a single molecule and at least one SCP is an aggregate of molecules.

An SCP is deemed a single molecule if any part of the SCP comprising a carbon atom is linked to the remaining part of SCP by means of one or more covalent bonds. An SCP is deemed an aggregate of molecules if a part of the SCP comprising a carbon atom is linked to the remaining part of SCP by means of one or more ionic bonds and/or hydrogen bonds.

In a preferred embodiment of the present invention, the SCP furthermore comprises a chemical group.

In the context of the present invention the term “chemical group” relates to any chemical group of potential interest for activation or modification of the PCM.

Examples of chemical groups suitable for such activation or modification may include ionic groups (cationic, e.g. quaternary amino groups, ammonium groups, carbocations, sulfonium groups, or metal cations, etc.; anionic, e.g., alcoxides, thiolates, phosphonates, carbanions, carboxylates, boronates, sulfonates, Bunte salts, etc.; or zwitterionic, e.g., amino acids, ylides, or other combinations of anionic and cationic groups on the same molecule) or their unionised conjugate acids or bases (as appropriate), hydrocarbons such as alkanes, alkenes, alkynes, aromatic or polycyclic aromatic hardcarbons and heterocycles uncharged hydrophilic groups (e.g. polyethers, such as polyethylene glycol), potentially reactive groups such as those containing electrophilic atoms (e.g., carbonyl compounds, carbocations, alkyl halides, acetals, etc.), nucleophiles (e.g., nitrogen, sulfur, oxygen, carbanions, etc.), or monomers for polymerisation reactions (free radical, e.g., acrylamide, bromobutyrate, vinyl, styrene, etc.; or otherwise, e.g., nucleophilic or electrophilic reagents), radioactive isotopes, free-radical precursors, carbene precursors, nitrene precursors, oxene precursors, nucleic acid sequences, amino acid sequences, polypeptides, proteins, carbohydrates, vitamins and drugs.

In a preferred embodiment of the present invention, the chemical group may be selected among polymerisation initiators or it may be selected among monomers for polymerisation reactions.

The polymerisation initiator may e.g. be an initiator for atom transfer radical polymerisation.

A suitable polymerisation initiator is e.g. 4-(2-(2-bromopropionyloxy)-ethoxy]benzoic acid (Zhang et al.), which may be linked to the SCP as described in Example 1.

Examples of suitable monomers for polymerisation are acrylamide, acrylic acid, acrylates, vinyl compounds (such as vinyl chloride), ethylene, propylene, styrene, derivatives thereof, and mixtures thereof.

The polymer resulting from polymerisation on the SCP may comprise ALGs, which may be useful for further cross-linking. Polymerised acrylic acid will for example comprise carboxylic acid groups, which are available for further reactions such as cross-linking.

It is also envisioned that a spacer group of a CLA may comprise a chemical group as defined herein. For example, the spacer group could comprise a chemical group for initiating polymerisation.

When used together with a CLA comprising one or more aldehydes, it may be preferred that the SCP comprises chemical groups that are primary amines.

The chemical group may e.g. comprise a carbohydrate material having a high affinity for boron compounds. A carbohydrate material having a high affinity for boron compounds may e.g. be one, which readily forms boron esters. This is especially advantageous when a boron compound, such as e.g. boric acid or salts thereof is used as CLA.

The carbohydrate material having a high affinity for the boron compounds may comprise an apiosyl residue.

The carbohydrate material having a high affinity for the boron compounds may comprise a 1->3′-linked apiosyl residue.

For example, the carbohydrate material having a high affinity for the boron compound may be rhamnogalacturonan II or a fragment thereof. Rhamnogalacturonan II may be prepared according to O'Neill et al.

The SCP comprising chemical groups may be prepared in many different ways. In an embodiment of the present invention, the SCP comprising chemical groups is prepared using organic synthesis which result in the formation of a bond between the chemical group and the SCP. Such bonds include, but are not limited to, ester, ether, sulphonate, silyl, (hemi)acetal, (hemi)ketal, phosphonate, or any number of acyl bonds. The chemistries involved in preparation of the SCP comprising chemical groups by organic synthesis are described in many handbooks such as e.g. March, Smith et al., and Collins et al.

In another embodiment of the present invention, the SCP comprising chemical groups may be prepared using an enzyme capable of activating the SCP, for example by oxidation. The SCP (a) is treated with an enzyme to yield a product (c) containing oxidised groups (b). Further modification of the oxidised groups may then be used to introduce other chemical groups (d) to produce a SCP comprising chemical groups (e).

In yet an embodiment of the present invention, the SCP comprising a chemical group may be prepared using an enzyme capable of transferring native or chemically modified mono- or oligosaccharides onto the ends of oligo- or polysaccharides. Such enzymes include but are not limited to enzymes which have high transglycosylation activity but low hydrolytic activity, glucosyl hydrolases with high inherent transglycosylation activity, enzymes, which have been biotechnically engineered to enhance their transglycosylation activity and glycosyl transferases, which use nucleotide sugars as substrates.

The enzyme may be selected from the group consisting of a transglycosylase, a glycosyl hydrolase, a glycosyl transferase. The enzyme may be a wild type enzyme or a functionally and/or structurally modified enzyme derived from such wild type enzyme. In an embodiment the enzyme is a xyloglucan endotransglycosylase (XET, EC 2.4.1.207). The preparation and use of XET in relation to the present invention is described in further detail in Fry et al., and in WO 03/033 813. The enzyme could also be another hemicellulose transglycosylase, such as the recently discovered mannan transglycosylase.

Preferably an enzyme is chosen having high transglycosylating activity and most preferably also for all practical purposes low or undetectable hydrolytic or other degradative activity. Preferably no nucleotide sugars or organic solvents are required to promote the transglycosylating activity. One example of such transglycosylating enzymes is xyloglucan endotransglycosylase, an enzyme known from plants.

For example, Stephen C. Fry et al, suggest in Biochem. J. 15 (1992) 282, p. 821-828 that XET is responsible for cutting and rejoining intermicrofibrillar xyloglucan chains and that XET thus causes the wall-loosening required for plant cell expansion. XET is believed to be present in all plants, in particular in all land plants. XET has been extracted from dicotyledons, monocotyledons, in particular graminaceous monocotyledons and liliaceous monocotyledons, and also from a moss and a liverwort. XET may be obtained as described in Fry et al.; in Kailas or in WO 03/033 813.

The inventors have found that SCPs such as xyloglucan polymers can be chemically and/or enzymatically modified to contain cross-linking groups. Further, the inventors have found that the SCP, even when modified with these groups, binds tightly to the surface of a PCM such as cellulose, and that the cross-linking groups introduced are nevertheless are accessible for further chemical reactions even when attached to the porous surfaces of PCMs via the SCP. In particular, such chemically modified xyloglucan polymers can be used as an interface for attaching polymers to cellulosic fibre surfaces. A significant advantage of the method is that the use of such an interface avoids subsequent loss of fibre structure and performance otherwise commonly encountered with direct chemical modification of cellulose.

The inventors have furthermore found that by cross-linking PCMs using SCPs and CLAs, it was surprisingly possible to significant gains in strength properties in materials composed of PCMs or composites thereof.

The composition may furthermore comprise a solvent. The solvent may e.g. be selected from the group consisting of a hydrophilic solvent, a hydrophobic solvent, an aqueous solvent, and a mixture thereof. In some embodiments an aqueous solvent is preferred.

The composition may furthermore comprise a divalent metal cation. The divalent metal cation may e.g. be selected from the group consisting of Mg²⁺, Ni²⁺, Cu²⁺, Zn²⁺, Cd²⁺, Ca²⁺, Sr²⁺, Pb²⁺, and Ba²⁺. In a preferred embodiment, the divalent metal cation is Ca²⁺.

The composition may furthermore comprise an additive. The additive may be selected from the group consisting of a buffer, a wetting agent, a stabiliser, an organic component reducing the water activity such as DMSO, and combinations thereof.

The buffer may suitably be a phosphate, borate, citrate, acetate, adipate, triethanolamine, monoethanolamine, diethanolamine, carbonate (especially alkali metal or alkaline earth metal, in particular sodium or potassium carbonate, or ammonium and HCl salts), diamine, especially diaminoethane, imidazole, Tris, or amino acid buffer. The wetting agent may serve to improve the wettability of the PCM. The wetting agent may either be a non-ionic surfactant type or an ionic surfactant type.

The composition may e.g. comprise PCM in the range of 0.1-99.9%.

It should be noted that, unless stated otherwise, a percentage mentioned herein is a weight/weight percentage.

The composition may e.g. comprise SCP in the range of 0.001-99.9%

The composition may e.g. comprise CLA in the range of 0.000000001-99.9%

The composition may e.g. comprise solvent in the range of 1-99.9%.

The weight ratio between the PCM and the SCP depends on the effective surface area of the PCM, as well as the size of the SCP. In a preferred embodiment of the invention the composition contains SCP in an amount that exceeds the maximum absorbable concentration of the specific SCP relative to the concentration of the specific PCM. However the protective effect of the SCP with respect to the PCM may be obtain if the composition comprises SCP in an amount of at least 20% of the maximum absorbable concentration of the specific SCP, preferably at least 50%, even more preferably at least 80% of the maximum absorbable concentration of the specific SCP, such as at least 90%.

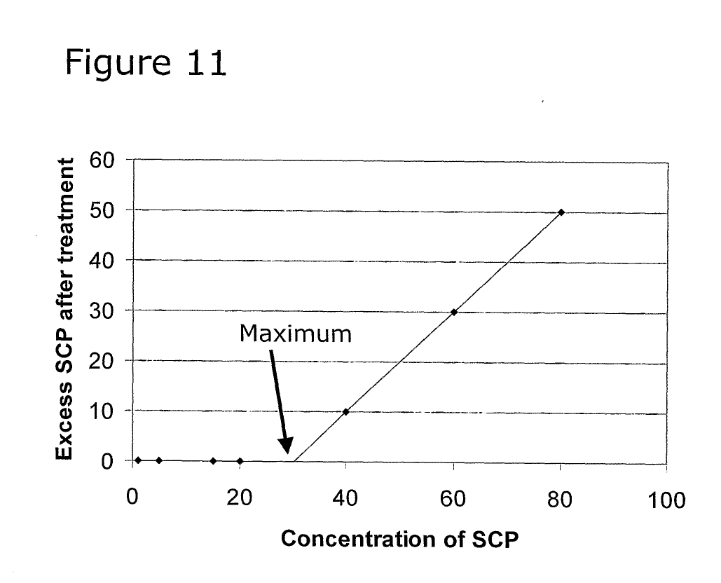

The “maximum absorbable concentration of the specific SCP” is a parameter with can determined experimentally as by treating samples of a fixed amount of the specific PCM with increasing concentrations of the specific SCP. By plotting the resulting data as shown in FIG. 11, the “maximum absorbable concentration of the specific SCP” can be determined on the X-axis as the SCP concentration where the line starts to rise (marked with “Maximum” in FIG. 11).

In an embodiment of the invention, which is typical for cross-linking of a paper pulp, the composition typically comprises PCM in the range of 0.5-70%, SCP in the range of 0.005-30%, CLA in the range of 0.00001-5%, and solvent in the range of 10-90%.

In an embodiment of the invention, which is typical for cross-linking of a pre-fabricated paper sheet, the composition typically comprises PCM in the range of 0.5-70%, SCP in the range of 0.005-30%, CLA in the range of 0.00001-5%, and solvent in the range of 10-90%.

In the composition, the PCM and the CLA may be in the weight to weight ratio interval 10000:1-1000:1, such as 10000:1-1000:1, 1000:1-100:1, 100:1-10:1, 10:1-1:1, 1:1-1:10, 1:10-1:100, or 1:100-1:1000.

In an important embodiment of the invention, the SCP is bound to the first PCM when provided in step a).

The first PCM may be in the solid state during the formation of the bond between the first PCM and the SCP, which e.g. takes place when preparing pre-bound SCP-PCM or in step b). Alternatively, the first PCM is either dissolved or solubilised in a suitable solvent during the formation of the bond between the first PCM and the SCP. Cellulose may for example be dissolved or solublilised in e.g. N-methylmorpholine-N-oxide (NMMO), lithium chloride/dimethylacetamide (LiCl/DIMAC), urea/hydroxide, etc. Typically, the PCM would then be re-precipitated from said solutions.

The method steps a-c) may be followed by a step d) of polymerisation. The composition of step d) will normally comprise the cross-linked material of step c), a polymerisation initiator, a monomer and optionally also a sacrificial initiator such as methyl 2-bromopropionate. Before starting the polymerisation reaction, the polymerisation initiator may e.g. be linked to the SCP as in Example I. Alternatively, a monomer may be linked to the SCP before starting the polymerisation reaction. Normally, the composition of step d) will always contain free monomer before start of the polymerisation reaction. The polymerisation reaction can both take place in liquid phase and in gas phase, thus, the monomers may either be present in gas state or may be present in liquid state or dissolved state.

The polymerisation of step d) may be a graft polymerisation, e.g. performed along the lines of Example I, thus using the same initiator and optionally also the same monomers. Alternative initiators and monomers may readily be identified by the person skilled in the art.

The polymerisation need not be performed at the time of formation of the cross-linked material. For example the polymerisation could be performed on a cross-linked material, such as a packaging material, after it has been shaped. Corners and folds of shaped materials comprising PCMs are typically weak and would benefit from the reinforcement of either polymerisation or additional cross-linking.

Another aspect of the present invention relates to a cross-linked material obtainable by any of the methods of the present invention.

Yet another aspect of the present invention relates to a cross-linked material comprising a first PCM cross-linked with a second material, wherein the cross-link comprises a SCP bound to the first PCM and a reacted CLA bound both to the SCP and the second material.

The first PCM, the SCP, the CLA, and second material of the cross-linked material may be selected among the various embodiments and alternatives described herein.

In the present context the term “bound” is meant to encompass both direct bonds and bonds involving intermediate groups/molecules forming a chain of direct bonds. For example, when the CLA is bound to the second PCM it may form one or more direct bonds to a hydroxy group of the PCM or it may form one or more direct bond to e.g. a SCP which again forms one or more direct bond to the second PCM. The bonds could e.g. be a covalent bond, or a non-covalent bonding interactions, such as hydrogen bonding, ionic bonding, or van der Waals interactions or combinations thereof. When the CLA is bound to the second material it may form one or more direct bonds to a any part of the second material or it may form one or more direct bond to e.g. a SCP which again forms one or more direct bond to the second material. The bonds could e.g. be a covalent bond, or a non-covalent bonding interactions, such as hydrogen bonding, ionic bonding, or van der Waals interactions or combinations thereof.

In a preferred embodiment of the invention, the bond(s) between SCP and CLA and the bond(s) between the CLA and the second material comprise a covalent bond.

In another preferred embodiment of the invention, the bond(s) between SCP and CLA and the bond(s) between the CLA and the second material comprise a covalent bond and/or an ionic bond.

In yet a preferred embodiment of the invention, the bond(s) between SCP and CLA and the bond(s) between the CLA and the second material comprise a covalent bond and/or an ionic bond and/or a hydrogen bond.

It is envisioned that the bond(s) between the CLA and the second material also comprise a bond due to van der Waals forces. Thus, in an embodiment of the invention, the bond(s) between SCP and CLA comprise a covalent bond and/or an ionic bond and/or a hydrogen bond, whereas the bond(s) between the CLA and the second PCM comprise a bond due to van der Waals forces.

The cross-linked material of the present invention can have numerous compositions. As the skilled person will appreciate, there exist embodiments where the PCM, the SCP and the CLA, respectively are the main components of the cross-linked material.

Generally, the cross-linked material may e.g. comprise PCM in the range of 0.1-99.9%. The cross-linked material may thus comprise PCM in the range of 0.1-10%, 10-20%, 20-30%, 30-40%, 40-50%, 50-60%, 60-70%, 70-80%, 80-90%, or 90-99.9%

The cross-linked material may e.g. comprise reacted SCP the range of 0.1-99.9%. The cross-linked material may thus comprise SCP in the range of 0.1-10%, 10-20%, 20-30%, 30-40%, 40-50%, 50-60%, 60-70%, 70-80%, 80-90%, or 90-99.9%

The cross-linked material may e.g. comprise at least 0.1% SCP such as at least 0.1%, 0.5%, 1%, 2%, 5%, 10%, 20%, 30%, 40%, 50%, 60%, 70%, 80%, 90%, or 95%, such as at least 99% SCP.

The cross-linked material may e.g. comprise reacted CLA in the range of 0.001-99.9%. The cross-linked material may thus comprise CLA in the range of 0.1-10%, 10-20%, 20-30%, 30-40%, 40-50%, 50-60%, 60-70%, 70-80%, 80-90%, or 90-99.9%

In an embodiment of the invention, which is typical for a pre-fabricated paper sheet which fibres have been cross-linked according to the present invention, the cross-linked material comprises PCM in the range of 60-99%, SCP in the range of 1-30% and reacted CLA in the range of 0.001-30%, such as PCM in the range of 80-95%, SCP in the range of 5-20% and reacted CLA in the range of 0.001-10%.

In an embodiment of the invention, which is typical for a strongly SCP-reinforced PCM material, the cross-linked material comprises PCM in the range of 30-70%, SCP in the range of 30-70% and reacted CLA in the range of 0.001-20%, such as PCM in the range of 40-60%, SCP in the range of 40-60% and reacted CLA in the range of 0.001-5%.

In an embodiment of the invention, which is typical for a PCM material in which the CLA comprises a bulky spacer group, the cross-linked material comprises PCM in the range of 20-40%, SCP in the range of 20-40% and reacted CLA in the range of 20-60%, such as PCM in the range of 20-30%, SCP in the range of 20-30% and reacted CLA in the range of 40-60%.

In an embodiment of the present invention, the cross-linked material comprises PCM and

SCP in the weight to weight ratio interval 10000:1-1:100, such as 10000:1-1000:1, 1000:1-100:1, 100:1-10:1, 10:1-1:1, 1:1-1:10, or 1:10-1:100. Typically, the cross-linked material comprises PCM and SCP in the weight to weight ratio interval 100:1-1:10.

In a preferred embodiment of the present invention, the cross-linked material comprises reacted CLA comprising elemental boron, such as a boron ester or derivatives thereof.

For example, 0.000000001%-5% of the weight of the cross-linked material is comprised by elemental boron, such as 0.000000001%-0.0000001%, 0.0000001%-0.00001%, 0.00001%-0.001%, 0.001%-0.01%, 0.01%-0.1%, 0.1%-1%, such as 1%-5% elemental boron.

The cross-linked material may furthermore comprise a divalent metal cation. The divalent metal cation may e.g. be selected form the group consisting of Mg²⁺, Ni²⁺, Cu²⁺, Zn²⁺, Cd²⁺, Ca²⁺, Sr²⁺, Pb²⁺, and Ba²⁺.

In a preferred embodiment of the present invention, the divalent metal cation is Ca²⁺.

The reacted CLA may comprise a reacted dialdehyde, such as a C2-C8 dialdehyde. For example, the dialdehyde may be glutardealdehyde.

Another aspect of the present invention relates to a kit comprising a SCP and a CLA. The kit may for example be for cross-linking and may e.g. be used in the method of cross-linking as described herein.

In an embodiment of the present invention, the SCP of the kit comprises the CLA, that is, the SCP is bound to the CLA. In another embodiment, the SCP of the kit does not comprise the CLA, that is, the SCP is not bound to the CLA. It is also envisioned that the kit may comprise the SCP bound to the CLA, SCP which is not bound to the CLA, and CLA which is not bound to the SCP.

The SCP and the CLA may be located in separate containers of the kit. Alternatively, they may be located in the same container. The SCP and/or the CLA of the kit may be present in liquid form, semi-liquid form, solid form or semi-solid form. For example, the SCP and the CLA of the kit may both be present in solid form.

The SCP and/or the CLA of the kit may be present in the form of a powder or a granulate.

The kit may furthermore comprise an additive as described herein.

In a preferred embodiment of the invention, the SCP and/or the CLA, preferably both the SCP and the CLA, are present in a ready to use formulation. In the present context the phrase “ready to use formulation” relates to a formulation that comprises all the necessary components, excluding the first PCM and/or the second material, for performing cross-linking according to the present invention. In an embodiment of the invention, the kit “ready to use formulation” does not comprise the solvent for performing the cross-linking. In an alternative embodiment, the “ready to use formulation” comprising the solvent, e.g. water or an organic solvent.

The cross-linked materials of the present invention have a large number of applications and may e.g. be used in a method of the preparation of e.g. paper or pulp products, filter papers, fine papers, newsprint, regenerated cellulose materials, liner boards, tissue and other hygiene products, sack and Kraft papers, other packaging materials, particle boards and fibre boards as well as surfaces of solid wood products or wood and fibre composites, cotton thread, corrugated cardboards, woven fabrics, auxiliary agents for a diagnostic or chemical assays or processes, packaging agents for liquids and foodstuffs, papers and cardboards laminated with a thermoplastic, such as polyethylene to provide an impermeable barrier to aqueous solutions, textiles, security papers, bank notes, traceable documents fillers, laminates and panel products, a wood-polymer composite, a polymer composite, alloys and blends, electrical conductors, semi-conductors, insulators, and cellulose derivates (cellulosics).

The cross-linked materials of the present invention have a large number of applications and may e.g. be used in method of the preparation of e.g. thermosensitive material, such as materials which automatically changes colour with the change of environment temperature. Thermosensitive materials changing colour at 37° C. is of particular interest. The cross-linked materials may furthermore be used in a method of the preparation of e.g. optical sensitive material, e.g. blocking certain range of wavelength such as e.g. UV-blocking.

The cross-linked materials of the present invention may e.g. be used as transparent materials, reflective materials, gas impermeable or semi-permeable materials, or as materials for reinforcement or armouring of other structures.

The cross-linked materials of the present invention may e.g. be used in a method of the preparation of medical membranes, gels, beads used in diagnostics or separation technology, and membranes used in electronic applications. The fibre product in the context of the present invention may also be a new type of composite with other natural or synthetic polymers or materials as well as those which may be considered electrical conductors, semi-conductors, or insulators.

Also, the cross-linked materials of the present invention may e.g. be used in method of the preparation of cellulose-containing fabrics, such as cotton, viscose, cupro, acetate and triacetate fibres, modal, rayon, ramie, linen, Tencel® etc., or mixtures thereof, or mixtures of any of these fibres, or mixtures of any of these fibres together with synthetic fibres or wool such as mixtures of cotton and spandex (stretch-denim), Tencel® and wool, viscose and polyester, cotton and polyester, and cotton and wool.

Yet a further aspect of the invention is a product selected from the group consisting of paper or pulp products, filter papers, fine papers, newsprint, regenerated cellulose materials, liner boards, tissue and other hygiene products, sack and Kraft papers, other packaging materials, particle boards and fibre boards as well as surfaces of solid wood products or wood and fibre composites, cotton thread, corrugated cardboards, woven fabrics, auxiliary agents for a diagnostic or chemical assays or processes, packaging agents for liquids and foodstuffs, papers and cardboards laminated with a thermoplastic, such as polyethylene to provide an impermeable barrier to aqueous solutions, textiles, security papers, bank notes, traceable documents fillers, laminates and panel products, a wood-polymer composite, a polymer composite, alloys and blends, electrical conductors, semi-conductors, insulators, medical membranes, gels, beads used in diagnostics or separation technology, cellulose-containing fabrics, such as cotton, viscose, cupro, acetate and triacetate fibres, modal, rayon, ramie, linen, Tencel® etc., or mixtures thereof, or mixtures of any of these fibres, or mixtures of any of these fibres together with synthetic fibres or wool such as mixtures of cotton and spandex (stretch-denim), Tencel® and wool, viscose and polyester, cotton and polyester, and cotton and wool and cellulose derivates (cellulosics);

said product comprising a cross-linked material according to the present invention.

### EXAMPLES

### Example I

### Graft Polymerisation of Methyl Methacrylate onto Cellulose

### Introduction

The present example demonstrates how to link a polymerisation initiator to a SCP and how to perform a graft polymerisation on cellulose by means of the SCP-polymerisation initiator conjugate.

The polymerisation initiator 4-(2-(2-Bromopropionyloxy)-ethoxy]benzoic acid which bears both an excellent ATRP initiator moiety and a convenient chromophoric tag, was coupled to the aminoalditol derivative of XGO (XGO-NH₂) and subsequently incorporated into xyloglucan (XG) with the XET enzyme. The small size of the XGO-NH₂ (ca. Mᵣ 1200) allows for precise synthetic and analytical chemistry to ensure complete derivatization, followed by a specific, controllable enzyme reaction to tailor XG chain length. Subsequent adsorption of initiator-bearing XG (XG-INI) to cellulose effectively tethers the initiator to the surface via a polyvalent interaction (XGO and derivatives do not themselves bind to cellulose, a XG chain>20 Glc units is required). For the present experiment, Whatman Grade 1 qualitative filter paper was chosen as a convenient, high purity cellulose fiber sheet, although the method is directly applicable to a wide variety of cellulose fibers and regenerated cellulose. Graft polymerization of MMA on the initiator-laden filter paper under appropriate ATRP conditions yields fibers which have altered surface properties.

### Materials

Xyloglucan (XG) from tamarind seed (Xyl:Glc:Gal:Ara=35:45:16:4) was purchased from Megazyme (Bray, Ireland). XET was obtained by heterologous expression of Populus tremula×tremuloides PttXET16A in Pichia pastoris according to Kailas. A mixture of xyloglucan oligosaccharides (XGO, XXXG/XLXG/XXLG/XLLG ratio 15:7:32:46) was prepared from deoiled tamarind kernel powder (300 Mesh, Maharashtra Traders, India) using endoglucanase digestion as described in Brumer et al. The aminoalditol derivatives of XGO (XGO-NH₂) were prepared by reductive amination as described by Brumer et al.

### Synthesis of Initiator-Modified XGO (XGO-INI)

4-(2-(2-Bromopropionyloxy)ethoxy)benzoic acid (synthesized according to Zhang et al., 267 mg, 0.84 mmol) and N-Ethyl-N′-(3-dimethylaminopropyl)carbodiimide (EDC, 149 μl, 0.84 mmol), were dissolved in N,N-dimethylformamide (DMF, 2 mL) and stirred at room temperature for 15 min. A solution of XGO-NH₂ (500 mg, 0.4 mmol) and 4,4-dimethylaminopyridine (5 mg, 0.04 mmol) in DMF (5 mL) was then added. The mixture was stirred at room temperature for 4 h, followed by the addition of acetone. The resulting precipitate was collected on Whatman GF/A glass microfibre filters, vacuum dried and purified on a C18 reversed phase column (Silica 60A 40-63 μm C18, SDS, France, 2.6 cm×10 cm) by stepwise elution with increasing concentrations of CH₃CN in water. Fractions containing pure products (TLC, 70:30 acetonitrile:water) were pooled and freeze-dried to give XGO-INI as a white powder (272 mg, yield in 44%).

### Attachment of Initiator to XG and Immobilization on Cellulose

Immobilization of the initiator onto the cellulose surface with XET technique was performed as follows. Initiator-modified XGO (XGO-INI) was obtained by reductive amination of XGO according to Brumer et al. and subsequent carbodiimide-mediated N-acylation with 4-(2-(2-bromopropionyloxy)-ethoxy]benzoic acid produced according to Zhang et al. A sample containing a 1 mL mixture of XG (1 g/L), XGO-INI (0.5 g/L) and XET (10 units) in NaOAc buffer (20 mM, pH 5.5) was incubated at 30° C. for 24 h. The reaction was terminated by heating at 75° C. for 10 min, and the denatured XET was removed by centrifugation at 12000 g for 20 min. The initiator-modified XG (XG-INI) produced in this manner had a M_{w} of 2.2×10⁴ (PDI=2.0). A filter paper disk (Whatman Grade 1, φ1.5 cm, average mass 15 mg) was added to the supernatant and incubated at 25° C. for 24 h with orbital shaking. The cellulose disk was then removed and washed with water (3×5 mL) in an end-over-end mixer and dried under vacuum at 60° C. for 48 h. The amount of XGO-INI incorporated into XG and subsequently bound to the filter paper disk was 0.06 μmol, as determined from the amount of XGO-INI (ε_{250 nm}=11000 cm⁻¹M⁻¹ in H₂O) remaining in the wash solutions.

### Polymerisation

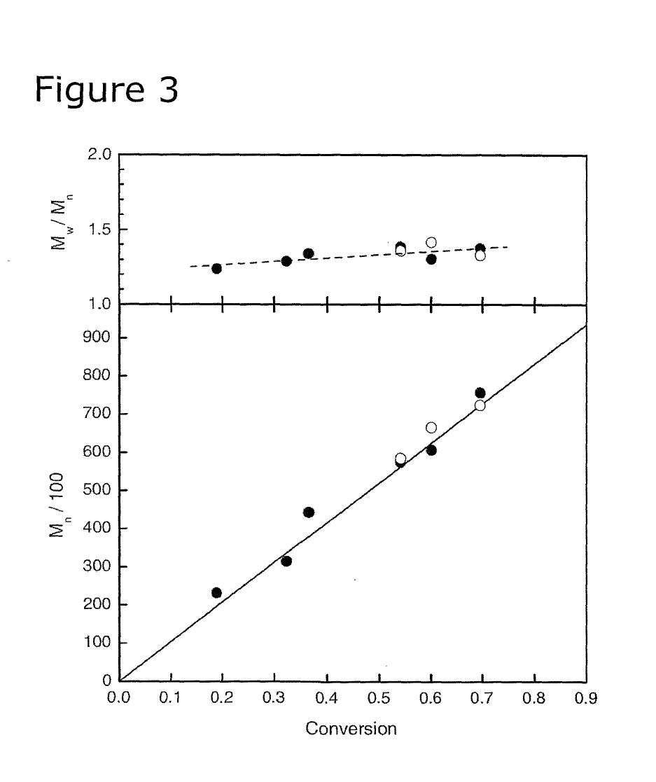

Initiator-laden Whatman filters were then placed into Schlenk reaction tubes containing a homogenous solution of MMA (2 mL, 18.7 mmol), methyl 2-bromopropionate (2 mL, 0.018 mmol), CuBr (5.7 mg, 0.04 mmol), dHbipy12 (28.2 mg, 0.08 mmol), diphenyl ether (2 mL, as solvent and internal standard) for graft ATRP. Following degassing by three freeze-pump-thaw cycles, the individual tubes were heated at 90° C. for 20, 40, 60, 120, 180 and 240 min with stirring (magnetic stir bar). The solution quickly turned reddish brown and the mixture gradually turned viscous as the polymerization proceeded. The methyl 2-bromopropionate working as a sacrificial initiator in solution brought about well-controlled polymerization with negligible contributions from transfer and termination reactions: The number-average molecular weight (Mn) of the free polymer produced in solution and the graft polymers on cellulose fiber surfaces increased linearly versus the conversion of MMA with a slope comparable to the theoretical value calculated from the initial ratio between the feed concentration of the monomer and free initiator (the amount of xyloglucan-immobilized initiator on the surface was negligible relative to the free initiator in solution). Additionally, the polydispersity index (Mw/Mn) of both polymers was relatively low, indicating that the graft polymerization process is as well controlled as the ATRP of MMA in solution as shown in FIG. 3. FIG. 3 shows a plot of Mn and Mw/Mn of the free polymers (solid circles) and cleaved polymers (open circles) as a function of monomer conversion. Solid line represents the theoretical Mn as a function of conversion; dashed line represents a linear least-squares fit to Mw/Mn versus conversion data.

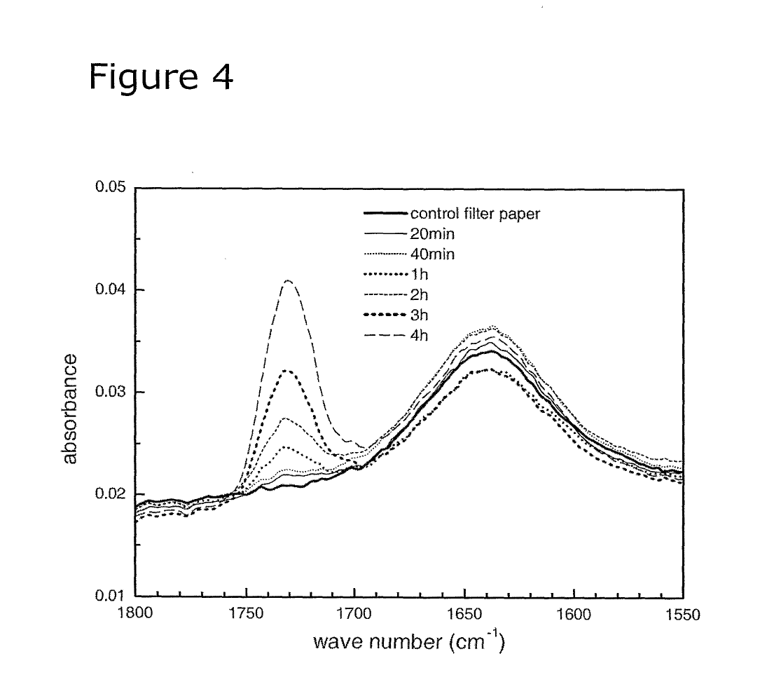

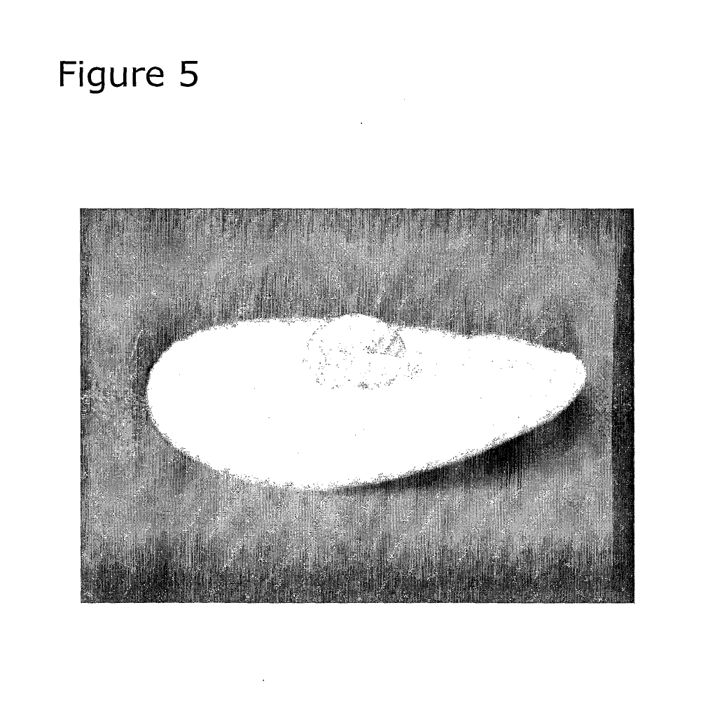

The filter papers were washed repeatedly with chloroform after polymerization and it was confirmed that the poly(MMA) chains were chemically anchored onto the cellulose fiber. Further evidence for the surface grafting of poly(MMA) was based on the appearance of the carbonyl peak (ν_{C=0}) at 1732 cm⁻¹ in ATR FTIR spectra of the washed filter papers, the intensity of which was proportional to the monomer conversion (FIG. 4). This strongly suggests that the thickness of the grafted layer can be controlled through the ATRP technique. Poly(MMA)-grafted filter papers from reactions where the free polymers had Mₙ<5×10⁴ (DP<500) absorbed water very slowly, while no water adsorption could be detected for samples from reactions yielding Mₙ>5×10⁴ (FIG. 5). The advancing angles (θₐ) for these highly hydrophobic cellulose papers were 120±6°, 126±5°, and 131±5° for samples with graft polymers of Mₙ 5.8×10⁴, 6.7×10⁴, and 7.2×10⁴, respectively (as shown in FIG. 3).

### Example II

### Attachment of Cinnamoyl Groups onto Cellulose Followed by Photoactivated Cross-Linking

### Introduction

The present example demonstrates how to link a cinnamoyl group to a SCP and how to perform a photoactivated cross-linking of cellulose by means of the SCP-cinnamoyl conjugate.

The cinnamoyl group was coupled to the aminoalditol derivative of XGO (XGO-NH₂) and subsequently incorporated into xyloglucan (XG) with the XET enzyme. The small size of the XGO-NH₂ (ca. Mᵣ 1200) allows for precise synthetic and analytical chemistry to ensure complete derivatization, followed by a specific, controllable enzyme reaction to tailor XG chain length. Subsequent adsorption of cinnamoyl-bearing XG (XG-CIN) to cellulose effectively tethers the initiator to the surface via a polyvalent interaction (XGO and derivatives do not themselves bind to cellulose, a XG chain>20 Glc units is required). For the present experiment, softwood chemical pulp was chosen as a cellulose source, although the method is directly applicable to a wide variety of cellulose fibers and regenerated cellulose. Hand sheets produced with pulp containing XG-CIN showed improved strength properties following irradiation with ultraviolet (UV) light.

### Materials

Xyfoglucan (XG) from tamarind seed (Xyl:Glc:Gal:Ara=35:45:16:4) was purchased from Megazyme (Bray, Ireland). XET was obtained by heterologous expression of Populus tremula×tremuloides PttXET16A in Pichia pastoris according to Kailas. A mixture of xyloglucan oligosaccharides (XGO, XXXG/XLXG/XXLG/XLLG ratio 15:7:32:46) was prepared from deoiled tamarind kernel powder (300 Mesh, Maharashtra Traders, India) using endoglucanase digestion as described in Brumer et al. The aminoalditol derivatives of XGO (XGO-NH₂) were prepared by reductive amination as described in Brumer et al.

Wood Pulp Bleached sulphate pulp from coniferous trees (mixed pine and spruce) (30 g) was resuspended by soaking in water overnight, followed by dilution to a final volume of 2 litre and complete mixing using 30 000 revolutions according to ISO 5263:1997. The cation content of the pulp was normalized following a method similar to the method previously described by Christiernin et al. The pH of the resulting suspension was lowered to 2 by adding HCl (1M, 20 ml) followed by stirring for 30 minutes. The fibers were collected by filtration and washed until the filtrate had a conductivity lower than 5 μS. The fibers were resuspended and NaHCO₃ (0.1 M, 20 ml) was added to convert the fibers to Na⁺+form. If pH 9 was not achieved after stirring for 10 minutes the suspension was titrated with NaOH (1 M) until pH 9, followed by stirring to achieve equilibrium (30 min). The fibers were again collected by filtration and washed until the filtrate had a conductivity lower than 5 μS. Pressure was then applied to the pulp to remove excess water.

### Synthesis of Cinnamoyl-Modified XGO (XGO-CIN)

XGO-NH₂ (500 mg, 0.4 mmol) was solved in DMF (15 ml). EDC hydrochloride (161 mg, 0.84 mmol, 2.1 equivalents), cinnamic acid (62.2 mg, 0.42 mmol, 1.05 equivalents) and 4,4′-dimethylaminopyridine (DMAP, 24.5 mg, 0.2 mmol, 0.5 equivalents) were quickly added in sequence and the reaction was stirred at room temperature for 20 h. The reaction mixture was poured into acetone (60 mL) with stirring. The resulting precipitate was collected on Whatman GF/A glass microfibre filters, vacuum dried and purified on a C18 reversed phase column (Silica 60 A 40-63 μm C18, SDS, France, 2.6 cm×10 cm) by stepwise elution with increasing concentrations of CH₃CN in water. Fractions containing pure product (TLC, 70:30 acetonitrile:water) were pooled and freeze-dried to give XGO-CIN as a white powder (440 mg, yield 78%).

### Attachment of the Cinnamoyl Group to XG and Immobilization on Cellulose

Attachment of the cinnamoyl group to XG was performed using the technique for the initiator group (above) by substituting XGO-CIN for XGO-INI. The resulting product, XG-CIN, was adsorbed to wood pulp by mixing 450 mg XG-CIN and 30 g pulp in 3 L of water overnight, followed by filtration and washing with water to remove unbound XG-CIN. Pressure was then applied to the pulp to remove excess water.

### Hand Sheet Formation

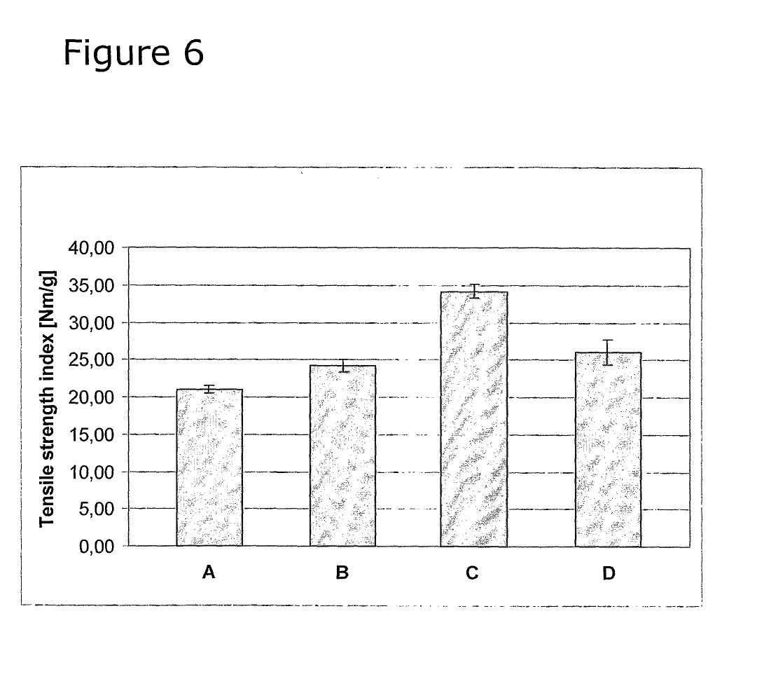

A Rapid Köthen Sheet Former (RK-3 KWT, PTI Paper Testing Instruments, GmbH, Vorchdorf, Austria) was used for hand sheet production according to method ISO 5269-2:1998. Prior to sheet formation, 2 g portions of pulp (based on dry mass) were suspended in ca. 500 mL water with stirring. Prior to the drying step, the formed sheets were irradiated for either 30 min (See results, FIG. 6) using a mercury lamp (30 W, main emission 254 nm, model G30T8, Philips, Eindhoven, The Netherlands) placed ca. 10 cm from the sheets. Sheets were then dried under vacuum in 93° C. for 12 min (ISO 5269-2:1998 indicates 10 min) using the Rapid Köthen apparatus. Control sheets consisted of either XG-CIN-bearing sheets which were not exposed to UV light, or sheets bearing xyloglucan lacking the cinnamoyl group (produced by reaction of XG and underivatized XGOs under the agency of the XET enzyme. Low molecular mass XG produced in this manner had molecular mass distribution essentially identical to XG-CIN).

### Example III

### Attachment of 4-azidobenzoyl Groups onto Cellulose Followed by Photoactivated Cross-Linking

### Introduction

In the present example, the demonstrates how to link a 4-azidobenzoyl group to a SCP and how to perform a photoactivated cross-linking of cellulose by means of the SCP-4-azidobenzoyl conjugate.

The 4-azidobenzoyl group was coupled to the aminoalditol derivative of XGO (XGO-NH₂) and subsequently incorporated into xyloglucan (XG) with the XET enzyme. The small size of the XGO-NH₂ (ca. Mᵣ 1200) allows for precise synthetic and analytical chemistry to ensure complete derivatization, followed by a specific, controllable enzyme reaction to tailor XG chain length. Subsequent adsorption of 4-azidobenzoyl-bearing XG (XG-N₃) to cellulose effectively tethers the initiator to the surface via a polyvalent interaction (XGO and derivatives do not themselves bind to cellulose, a XG chain >20 Glc units is required). For the present experiment, softwood chemical pulp was chosen as a cellulose source, although the method is directly applicable to a wide variety of cellulose fibers and regenerated cellulose. Hand sheets produced with pulp containing XG-N₃ showed improved strength properties following irradiation with ultraviolet (UV) light.

### Materials

Xyloglucan (XG) from tamarind seed (Xyl:Glc:Gal:Ara=35:45:16:4) was purchased from Megazyme (Bray, Ireland). XET was obtained by heterologous expression of Populus tremula×tremuloides PttXET16A in Pichia pastoris according to Kailas. A mixture of xyloglucan oligosaccharides (XGO, XXXG/XLXG/XXLG/XLLG ratio 15:7:32:46) was prepared from deoiled tamarind kernel powder (300 Mesh, Maharashtra Traders, India) using endoglucanase digestion as described in Brumer et al. The aminoalditol derivatives of XGO (XGO-NH₂) were prepared by reductive amination as described in by Brumer et al.

Wood Pulp Bleached sulphate pulp from coniferous trees (mixed pine and spruce) (30 g) was resuspended by soaking in water overnight, followed by dilution to a final volume of 2 litre and complete mixing using 30 000 revolutions according to ISO 5263:1997. The cation content of the pulp was normalized as follows following a method similar to the method of previously described in Christiernin et al. The pH of the resulting suspension was lowered to 2 by adding HCl (1M, 20 ml) followed by stirring for 30 minutes. The fibers were collected by filtration and washed until the filtrate had a conductivity lower than 5 μS. The fibers were resuspended and NaHCO₃ (0.1 M, 20 ml) was added to convert the fibers to Na⁺ form. If pH 9 was not achieved after stirring for 10 minutes the suspension was titrated with NaOH (1 M) until pH 9, followed by stirring to achieve equilibrium (30 min).

The fibers were again collected by filtration and washed until the filtrate had a conductivity lower than 5 μS. Pressure was then applied to the pulp to remove excess water.

Synthesis of 4-azidobenzoyl-modified XGO (XGO-N₃)

N-hydroxysuccinimidyl-4-azidobenzoate (66.3 mg, 0.255 mmol, 1.0 equivalents; Sigma-Aldrich, catalog no. A-9048) was added to a solution of XGO-NH₂ (314.8 mg, 0.247 mmol) in dimethyl formamide (DMF, 24 ml). After stirring in room temperature for four hours, the DMF was evaporated at 50° C. under vacuum. The solid was extracted with water and the resulting solution was purified on a C18 reversed phase column (Silica 60A 40-63 μm C18, SDS, France, 2.6 cm×10 cm) by stepwise elution with increasing concentrations of CH₃CN in water. Fractions containing pure products (TLC, 70:30 acetonitrile:water) were pooled and freeze-dried to give XGO-N₃ as a white powder.

Attachment of the 4-azidobenzoyl Group to XG and Immobilization on Cellulose

Attachment of the 4-azidobenzoyl group to XG was performed using the technique for the initiator group (above) by substituting XGO-N₃ for XGO-INT. The resulting product, XG-N₃, was adsorbed to wood pulp by mixing 450 mg XG-N₃ and 30 g pulp in 3 L of water overnight, followed by filtration and washing to remove unbound XG-N₃. Pressure was then applied to the pulp to remove excess water.

### Hand Sheet Formation

A Rapid Köthen Sheet Former (RK-3 KWT, PTI Paper Testing Instruments, GmbH, Vorchdorf, Austria) was used for hand sheet production according to method ISO 5269-2:1998. Prior to sheet formation, 2 g portions of pulp (based on dry mass) were suspended in ca. 500 mL water with stirring. Prior to the drying step, the formed sheets were irradiated for either 30 min (See results, FIG. 6) using a mercury lamp (30 W, main emission 254 nm, model G30T8, Philips, Eindhoven, The Netherlands) placed ca. 10 cm from the sheets. Sheets were then dried under vacuum in 93° C. for 12 min (ISO 5269-2:1998 indicates 10 min) using the Rapid Köthen apparatus. Control sheets consisted of either XG-N₃-bearing sheets which were not exposed to UV light, or sheets bearing xyloglucan lacking the 4-azidobenzoyl group (produced by reaction of XG and underivatized XGOs under the agency of the XET enzyme. Low molecular mass XG produced in this manner had molecular mass distribution essentially identical to XG-N₃).

### Tensile Strength Tests

Hand sheets were conditioned for 24 h at 23° C. and a relative humidity of 50%. Tensile strength testing was performed under these conditions according to SCAN standard method SCAN-P 67:93. Results are summarized in the bar graph of FIG. 6. FIG. 6 shows the tensile strength index of hand sheets: A is without added xyloglucan; B is with adsorbed unmodified xyloglucan; C is with adsorbed XG-CIN; D is with adsorbed XG-N₃. Xyloglucan in samples B, C, and D had a weigh-average molecular mass, M_{w}, of 2.2×10⁴ (PDI=2.0). Samples B, C, and D were irradiated for 30 min prior to drying; no statistical difference in tensile strength was observed for sheets irradiated after drying.

### Example IV

### Xyloglucan-Mediated Boron Cross-Linking of Wood Pulp

Adsorption of XG to Pulp and Cross-Linking with Boric Acid

Wood Pulp: Bleached sulphate pulp from coniferous trees (mixed pine and spruce) (30 g) was resuspended by soaking in water overnight, followed by dilution to a final volume of 2 litre and complete mixing using 30 000 revolutions according to ISO 5263:1997. The cation content of the pulp was normalised as follows following a method similar that previously described by Christiernin et al. The pH of the resulting suspension was lowered to 2 by adding HCl (1M, 20 ml) followed by stirring for 30 minutes. The fibers were collected by filtration and washed until the filtrate had a conductivity lower than 5 μS. The fibers were resuspended and NaHCO₃ (0.1 M, 20 ml) was added to convert the fibers to Na⁺ form. If pH 9 was not achieved after stirring for 10 minutes the suspension was titrated with NaOH (1 M) until pH 9, followed by stirring to achieve equilibrium (30 min). The fibers were again collected by filtration and washed until the filtrate had a conductivity lower than 5 μS. Pressure was then applied to the pulp to remove excess water.

A number of samples were produced to show the added benefit of cross-linking xyloglucan-treated wood pulps with boron acid, as summarised in Table 1:

TABLE 1
Preparation of wood pulp for boron cross-linking

| Sample | Treatment A | Treatment B |
|---|---|---|
| 1 | XG^{a} 1% (w/w pulp) in water, 18 h | B(OH)₃ 0.1% (w/v) in water, pH 3.5, 24 h |
| 2 | XG^{a} 1% (w/w pulp) in water, 18 h | B(OH)₃ 0.01% (w/v) in water, pH 3.5, 24 h |
| 3 | XG^{a} 1% (w/w pulp) in water, 18 h | B(OH)₃ 0.1% (w/v) in water, pH 3.5, 0 min |
| 4 | XG^{a} 1% (w/w pulp) in water, 18 h | B(OH)₃ 0.01% (w/v) in water, pH 3.5, 0 min |
| 5 | XG^{a} 1% (w/w pulp) in water, 18 h | pH 3.5, 24 h |
| 6 | none | B(OH)₃ 0.1% (w/v) in water, pH 3.5, 24 h |
| 7 | none | B(OH)₃ 0.01% (w/v) in water, pH 3.5, 24 h |
| 8 | none | B(OH)₃ 0.1% (w/v) in water, pH 3.5, 0 min |
| 9 | none | B(OH)₃ 0.01% (w/v) in water, pH 3.5, 0 min |

^{a}XG = xyloglucan, used as supplies by Megazyme (Bray, Ireland).

Where xyloglucan was adsorbed as a first treatment of the wood pulp (Table 1, Samples 1-5), xyloglucan (40 mg) was dissolved in 400 mL deionized water. Wood pulp (4 g) was then added and the suspension was stirred 18 h at room temperature. At that time, the suspension was filtered and the pulp solids were washed with water to remove excess xyloglucan. For Samples 6-9, Treatment A was omitted and the wood pulp was used directly for Treatment B. Treatment B consisted of resuspending the wood pulp in either: 0.1% w/v aqueous boric acid, pH 3.5; 0.01% aqueous boric acid, pH 3.5; or water, pH 3.5 for time periods of either 0 min or 24 h prior to hand sheet formation (Table 1). In all cases, the pH of the solution was adjusted by the addition of 100 mM aqueous HCl after the addition of the pulp. Hand sheets to be tested were produced from each sample (2 g pulp/sheet) after Treatment B on a Rapid Köthen Sheet Former (RK-3 KWT, PTI Paper Testing Instruments, GmbH, Vorchdorf, Austria), according to method ISO 5269-2:1998.

### REFERENCES

Brumer et al.: Brumer, H., III; Zhou, Q.; Baumann, M. J.; Carlsson, K.; Teeri, T. T. J. Am. Chem. Soc. 2004, 126, 5715.
Collins et al. Collins, P.; Ferrier, R. Monosaccharides, John Wiley & Sons, 1995
Christiernin et al. Christiernin, M., Henriksson, G., Lindstrom, M. E., Brumer, H., Teeri, T. T., Lindstrom, T. and Laine, J. (2003) The effects of xyloglucan on the properties of paper made from bleached kraft pulp. Nord. Pulp Paper Res. J., 18, 182-187.
Fry et al.: Fry, S. C.; York, W. S.; Albersheim, P.; Darvill, A.; Hayashi, T.; Joseleau, J. P.; Kato, Y.; Lorences, E. P.; Maclachlan, G. A.; Mcneil, M.; Mort, A. J.; Reid, J. S. G.; Seitz, H. U.; Selvendran, R. R.; Voragen, A. G. J.; White, A. R. Physiol. Plant. 1993, 89, 1.
Greene & Wuts Theodora W. Greene, Peter G. M. Wuts; Protective Groups in Organic Synthesis; 3rd Edition; June 1999; John Wiley & Sons Inc ISBN: 0-471-16019-9
Gustaysson et al. Modification of Cellulose Fiber Surfaces by Use of a Lipase and a Xyloglucan Endotransglycosylase; Malin T. Gustaysson, Per V. Persson, Tommy Iversen, Mats Martinelle, Karl Hult, Tuula T. Teeri, and Harry Brumer III; Biomacromolecules; 2005; 6(1) pp 196-203
Kailas Åsa Kailas, Licentiate thesis, 2004, Royal Institute of Technology (KTH), Stockholm, Sweden, http://media.lib.kth.se/licengrefhit.asp?licnr=1703)
Kocienski Philip Kocienski; Protection groups; 3rd Edition, 2003, Georg Thieme Verlag; ISBN: 3-13-137003-3
Kolb, et al. Angewandte Chemie International Edition, Volume 40, Issue 11, Pages 2004-2021, 2001
March Jerry March, Advanced Organic Chemistry, 4^{th} ed., John Wiley & Sons, New York, 1992.
O'Neill et al. O'Neill et al.; Journal of Biological Chemistry; Vol. 271; No. 37; Issue of 13 Sep.; pp. 22923-22930; 1996
Oldring et al. 1 Chemistry and Technology of UV and EB Formulation for Coatings, Inks and Paints: UV Curing Equipment and Application Systems v. 1 (Wiley/SITA Series in Surface Coatings Technology) P. Oldring (Editor), T. Benejka (Editor), R. Mehnert (Editor), D. Stowe (Editor) Publisher: John Wiley and Sons Ltd ISBN: 0471978906
Oldring et al. 2 Chemistry and Technology of UV and EB Formulation for Coatings, Inks and Paints: Photoinitiators for Free Radical, Cationic and Anionic Polymerisation v. 3 (Wiley/SITA Series in Surface Coatings Technology) P. Oldring (Editor), K. Dietliker (Editor), J. V. Crivelio (Editor) Publisher: John Wiley and Sons Ltd ISBN: 0471978922
Smith et al. Michael B. Smith and Jerry March, March's Advanced Organic Chemistry: Reactions, Mechanisms, and Structure, 5^{th} ed., John Wiley & Sons, New York, 2001.
Zhang et at. Zhang, X.; Matyjaszewski, K. Macromolecules 1999, 32, 7349.
WO 03/033 813
U.S. Pat. No. 6,844,081

1. A method of cross-linking a first polymeric carbohydrate material (PCM) and a second material, the method comprising the steps:
a) providing a composition comprising said first PCM, said second material, a soluble carbohydrate polymer (SCP) and a cross-linking agent (CLA), said SCP being capable of binding to the first PCM, said CLA comprising a first activatable linking group (ALG) and a second ALG, which ALGs can form at least one bond to another molecule upon activation by a method of activation,
b) binding the SCP to the first PCM, and
c) cross-linking the first PCM and the second material via the SCP and the CLA by activating the first activatable linking group and/or the second activatable linking group by at least one method of activation.

2. A method of cross-linking a first polymeric carbohydrate material (PCM) and a second PCM, the method comprising the steps:
a) providing a composition comprising said first PCM, said second material, a soluble carbohydrate polymer (SCP) bound to the first PCM, and a cross-linking agent (CLA), said CLA comprising a first ALG and a second activatable linking group, second ALG, which ALGs can form at least one bond to another molecule upon activation by a method of activation, and
b) cross-linking the first PCM and the second material via the SCP and the CLA by activating the first activatable linking group and/or the second activatable linking group by at least one method of activation.

3. The method according to claim 1, wherein the second material is a second PCM.

4. The method according to claim 1, wherein the first and second ALG can be activated via the same method of activation.

5. The method according to claim 1, wherein the first ALG cannot be activated by a method of activation of which the second ALG can be activated.

6. The method according to claim 1, wherein the second ALG cannot be activated by a method of activation of which the first ALG can be activated.

7. The method according to claim 1, wherein the CLA furthermore comprises a spacer group to which the first and/or second activatable linking group are attached.

8. The method according to claim 7, wherein the spacer group is selected from a group of an atom, a protein, a polypeptide, a small organic molecule, a carbohydrate, or a nano particle.

9. The method according to claim 7, wherein the spacer group comprises at most 99.5% xyloglucan, such as at most 99%, 95%, 90%, 80%, 70%, 60%, 50%, 40%, 30%, 20%, 10%, or 5%, such as at most 1% xyloglucan.

10. The method according to claim 7, wherein the spacer group does not comprise xyloglucan.

11. The method according to claim 7, wherein the spacer group is not a SCP.

12. The method according to claim 7, wherein the spacer group comprises at most 99.5% cellulose, such as at most 99%, 95%, 90%, 80%, 70%, 60%, 50%, 40%, 30%, 20%, 10%, or 5%, such as at most 1% cellulose.

13. The method according to claim 7, wherein the spacer group does not comprise cellulose.

14. The method according to claim 7, wherein the spacer group is not a PCM.

15. The method according to claim 1, wherein the longest dimension of the CLA is at most 100 μm, such as at most 50 μm, 25 μm, 10 μm, 5 μm, or at most 1 μm, such as e.g. at most 500 nm, 250 nm, 125 nm, 100 nm, 75 nm, 50 nm, 25 nm, 12.5 nm, 10 nm, 5 nm, 2.5 nm, 1.25 nm, 1.0 nm, 0.5, or at most 0.1 nm.

16. The method according to claim 1, wherein the activatable linking group inherently is capable of cross-linking carbohydrates.

17. The method according to claim 1, wherein the activatable linking group is selected from the group consisting of a photo-activatable group, ionic groups, hydrocarbons, electrophilic groups, nucleophilic groups, monomers for polymerisation reactions, radioactive isotopes, free-radical precursors, carbene precursors, nitrene precursors, oxene precursors, nucleic acid sequences, amino acid sequences, polypeptides, proteins, carbohydrates, vitamins and drugs.

18. The method according to claim 1, wherein the SCP of step a) comprises the CLA.

19. The method according to claim 1, wherein the SCP of step a) does not comprise the CLA.

20. The method according to claim 1, wherein the method of activation is selected from the group consisting of
exposing the composition to ionizing radiation,
exposing the composition to electromagnetic radiation,
creating an acidic pH in the composition,
creating a basic pH in the composition,
providing a suitable solvent,
creating a certain temperature in the composition,
adding a catalyst/chemical activator, and
combinations thereof.

21. The method according to claim 20, wherein the method of activation is exposing the composition to electromagnetic radiation.

22. The method according to claim 21, wherein the composition is exposed to the electromagnetic radiation for a duration in the range of 0.1 second-20 hours, such as 0.1-1 second, 1-10 seconds, 10-30 seconds, 30-60 seconds, 1-10 minutes, 10-30 minutes, 30-60 minutes, 1-5 hours, 5-10 hours or 10-20 hours.

23. The method according to claim 21, wherein the electromagnetic radiation comprises a wavelength within the wavelength range 150 nm-1500 nm, such as within 150 nm-400 nm, 400 nm-700 nm, or 700 nm-1500 nm.

24. The method according to claim 21, wherein at least 10% of the energy of the electromagnetic radiation, to which the composition is exposed, consists of wavelengths within the wavelength range 150 nm-1500 nm, such as within 150 nm-400 nm, 400 nm-700 nm, or 700 nm-1500 nm.

25. The method according to claim 21, wherein at least 50% of the energy of the electromagnetic radiation, to which the composition is exposed, consists of wavelengths within the wavelength range 150 nm-1500 nm, such as within 150 nm-400 nm, 400 nm-700 nm, or 700 nm-1500 nm.

26. The method according to claim 1, wherein the first and/or the second PCM is/are a water-insoluble polysaccharide.

27. The method according to claim 1, wherein the first and/or the second PCM comprises at least 5% cellulose, such as at least 10%, 20%, 30%, 40%, 50%, 60%, 70%, 80%, 95%, or 99%, such as at least 99.9% cellulose, such as e.g. 100% cellulose.

28. The material according to claim 1, wherein the first and/or the second PCM are derived from a source selected from the group consisting of a plant, a bacterium, an algea and an animal.

29. The method according to claim 1, wherein the first and/or the second PCM of step a) of claim 1 form part of a structure selected from the group consisting of
i) microcrystalline cellulose,
ii) cellulose microfibrils,
iii) regenerated cellulose,
iv) plant fibers such as fibers extracted from plants,
v) partially defibrillated wood,
vi) wood,
vii) a fibre network, and
viii) composite materials comprising any combination of i)-vii).

30. The method according to claim 1, wherein the SCP comprises a component selected from the group consisting of a hemicellulose, a pectin and a starch.

31. The method according to claim 30, wherein the SCP comprises xyloglucan.

32. The method according to claim 31, wherein the SCP essentially consists of xyloglucan.

33. The method according to claim 30, wherein the SCP comprises at least 1% xyloglucan, such as at least 2%, 5%, 10%, 20%, 30%, 40%, 50%, 60%, 70%, 80%, 95%, or 99%, such as at least 99.9% xyloglucan, such as e.g. 100% xyloglucan.

34. The method according to claim 30, wherein the SCP comprises at most 100% xyloglucan, such as at most 99.9%, 99.5%, 99%, 95%, 90%, 80%, 70%, 60%, 50%, 40%, 30%, 20%, 10%, or 5%, such as at most 1% xyloglucan.

35. The method according to claim 1, wherein the SCP further comprises a chemical group.

36. The method according to claim 35, wherein the chemical group is selected from the group consisting of a primary amine, and a thiol.

37. The method according to claim 35, wherein the chemical group comprises a carbohydrate material having a high affinity for boron compound (readily forms boron esters).

38. The method according to claim 37, wherein the carbohydrate material having a high affinity for the boron compound comprises an apiosyl residue.

39. The method according to claim 38, wherein the carbohydrate material having a high affinity for the boron compound comprises a 1-3′-linked apiosyl residue.

40. The method according to claim 39, wherein the carbohydrate material having a high affinity for the boron compound is rhamnogalacturonan II.

41. The method according to claim 1, wherein the composition furthermore comprises a solvent.

42. The method according to claim 41, wherein the solvent is selected from the group consisting of a hydrophilic solvent, a hydrophobic solvent, an aqueous solvent, and a mixture thereof.

43. The method according to claim 41, wherein the composition comprises 0.1-99.9% PCM, 0.1-99.9% SCP, 0.001-99.9% CLA, and 0.001-99.9% solvent.

44. The method according to claim 1, wherein the composition comprises PCM and CLA in the weight to weight ratio interval 10000:1-1000: 1.

45. The method according to claim 1, wherein the composition furthermore comprises a divalent metal cation.

46. The method according to claim 45, wherein the divalent metal cation is selected from the group consisting of Mg²⁺, Ni²⁺, Cu²⁺, Zn²⁺, Cd²⁺, Ca²⁺, Sr²⁺, Pb²⁺, and Ba²⁺.

47. The method according to claim 46, wherein the divalent metal cation is Ca²⁺.

48. The method according to claim 1, wherein the SCP is pre-bound to the first PCM when provided in step a).

49. The method according to claim 1, wherein the first PCM is in solid state during the formation of the bond between the first PCM and the SCP.

50. The method according to claim 1, wherein the first PCM is either dissolved or solubilised during the formation of the bond between the first PCM and the SCP.

51. A cross-linked material obtainable according to claim 1.

52. A cross-linked material comprising a first PCM cross-linked with a second material, wherein the cross-link comprises a SCP bound to the first PCM and a reacted CLA bound both to the SCP and the second material.

53. The cross-linked material of claim 52, wherein the second material is a second PCM.

54. The cross-linked material according to claim 52, wherein the cross-linked material comprises 0.01-99.9% PCM and 0.001-99.9% SCP.

55. The cross-linked material according to claim 52, wherein the cross-linked material further comprises 0.001-50% reacted CLA.

56. The cross-linked material according to claim 52, wherein the cross-linked material comprises PCM and SCP in the weight to weight ratio interval 10000:1-1000:1.

57. The cross-linked material according to claim 52, wherein the reacted CLA comprises elemental boron, such as a boron ester or derivatives thereof.

58. The cross-linked material according to claim 57, wherein 0.000000001%-5% of the weight of the cross-linked material is comprised by elemental boron, such as 0.000000001%-0.0000001%, 0.0000001%-0.00001%, 0.00001%-0.001%, 0.001%-0.01%, 0.01%-0.1%, 0.1%-1%, such as 1%-5% elemental boron.

59. The cross-linked material according to claim 52, the cross-linked material further comprising a divalent metal cation.

60. The cross-linked material according to claim 59, wherein the divalent metal cation is selected form the group consisting of Mg²⁺, Ni²⁺, Cu²⁺, Zn²⁺, Cd²⁺, Ca²⁺, Sr²⁺, Pb²⁺, and Ba²⁺.

61. The cross-linked material according to claim 60, wherein the divalent metal cation is Ca²⁺.

62. The cross-linked material according to claim 52, wherein the reacted CLA comprises a reacted dialdehyde, such as a C2-C8 dialdehyde.

63. The cross-linked material according to claim 62, wherein the dialdehyde is glutardealdehyde.

64. A kit comprising a SCP and a CLA.

65. Use of a cross-linked material according to claim 52 in the preparation of a product selected from the group consisting of paper or pulp products, filter papers, fine papers, newsprint, regenerated cellulose materials, liner boards, tissue and other hygiene products, sack and Kraft papers, other packaging materials, particle boards and fibre boards as well as surfaces of solid wood products or wood and fibre composites, cotton thread, corrugated cardboards, woven fabrics, auxiliary agents for a diagnostic or chemical assays or processes, packaging agents for liquids and foodstuffs, papers and cardboards laminated with a thermoplastic, such as polyethylene to provide an impermeable barrier to aqueous solutions, textiles, security papers, a bank notes, traceable documents fillers, laminates and panel products, a wood-polymer composite, a polymer composite, alloys and blends, electrical conductors, semi-conductors, insulators, and cellulose derivates (cellulosics).
